(19) United States
(12) Patent Application Publication
(10) Pub. No.: US 2025/0086586 A1
(43) Pub. Date: Mar. 13, 2025

(54) INVENTORY MANAGEMENT DEVICE

(71) Applicant: SAUDI ARABIAN OIL COMPANY, Dhahran (SA)

(72) Inventor: Saud Al-Temyatt, Dhahran (SA)

(73) Assignee: SAUDI ARABIAN OIL COMPANY, Dhahran (SA)

(21) Appl. No.: 18/466,274

(22) Filed: Sep. 13, 2023

(51) Int. Cl. G06Q 10/0875; G06Q 10/0631

(52) U.S. Cl. CPC G06Q 10/0875; G06Q 10/06315

(57) ABSTRACT

An inventory management device includes a transceiver and a processor. The transceiver receives existing inventory information specifying parts required to build a product for a wellsite procedure. The processor executes a forecasting module, an outlier module, a scheduling module, an averaging module, and an inventory management module, which form a demand quantity prediction unit. The forecasting module adds the existing inventory information to an AI database that stores inventory data of historically available parts and products. The outlier module creates filtered inventory data by removing statistically abnormal information from the inventory data of the AI database. The forecasting module determines an available quantity of parts from a moving average of the filtered inventory data computed by the averaging module. The inventory management module places an order for parts based upon a difference between the forecast available and required quantities of parts for a scheduled date stored in the scheduling module.

### BACKGROUND

In order to efficiently mass produce a product for use in an oil and gas related operation, such as a drill bit used to drill a wellbore, the product is assembled or manufactured in a series of stages that form a supply chain. Typically, the supply chain includes entities such as a supplier that delivers raw parts, materials, and other goods to a manufacturing facility run by a manufacturer. The manufacturer proceeds to build products and assemblies from the raw parts in order to form a product used during a well operation. The product is then used at the wellsite as part of the oil and gas operation, and may be used directly by the manufacturer, or by a third party consumer, for example. Alternatively, if the mass produced product is a product of the oil and gas operation, such as barrels of oil, the supply chain includes the manufacturer collecting the oil and distributing the barrels of oil to a consumer.

Regardless of the purpose of the supply chain in relation to the oil and gas operation, various logistical challenges can arise as a result of multiple entities of the supply chain interacting. For example, a supplier may be unable to deliver raw goods and parts to the manufacturer, or the manufacturer may not be able to produce a required number of products for a consumer. In such cases, it is necessary to track inventory changes related to the aforementioned logistical problems, and manage the inventory of products located at a manufacturer facility as a whole. Such revisions may include communicating with a supplier to request additional raw goods and parts, or adjusting the production rate of the manufacturer facility to account for the undelivered raw goods and parts.

### SUMMARY

An inventory management device includes a transceiver and a processor. The transceiver receives existing inventory information from a supplier facility that specifies an available quantity of one or more parts required to build a product that is used at a wellsite to complete one or more wellsite procedures. The processor executes a time-series forecasting module, an outlier module, a scheduling module, an averaging module, and an inventory management module, which form a demand quantity prediction unit. The time-series forecasting module receives and adds the existing inventory information to an AI database including previous inventory information. Consequently, the AI database includes time-series inventory data comprising a historically available quantity of the parts and further includes a historically available quantity of products built by the manufacturing facility. The outlier module removes statistically abnormal inventory information from the time-series inventory data to create filtered time-series inventory data. The scheduling module receives and stores a required quantity of the part for use at a scheduled date. The averaging module computes a moving average of the filtered time-series inventory data to create average inventory data. The time-series forecasting module further determines a forecast available quantity of parts for use at the scheduled date based upon the average inventory data. The inventory management module predicts a difference between the forecast available quantity of the parts and the required quantity of the parts for the scheduled date, and automatically places an order for one or more additional parts from the supplier facility based upon the difference.

A method for managing an inventory of a product used at a wellsite to complete one or more wellsite procedures includes receiving existing inventory information from a supplier facility with a transceiver. The existing inventory information specifies an available quantity of one or more parts required to build the product at a manufacturing facility. The method further includes executing, with a processor, a series of modules that form a demand quantity prediction unit. The execution includes receiving the existing inventory information with a time-series forecasting module of the demand quantity prediction unit. Subsequently, the existing inventory information is added with the time-series forecasting module to an AI database that includes previous inventory information such that the AI database includes time-series inventory data with a historically available quantity of the parts and a historically available quantity of products built by the manufacturing facility. The execution further includes removing statistically abnormal inventory information from the time-series inventory data with an outlier module of the demand quantity prediction unit to create filtered time-series inventory data. A required quantity of the part for use at a scheduled date is received and stored with a scheduling module of the demand quantity prediction unit. An averaging module of the demand quantity prediction unit computes a moving average of the filtered time-series inventory data to create average inventory data. The time-series forecasting module determines a forecast available quantity of parts for use at the scheduled date based upon the average inventory data. An inventory management module of the demand quantity prediction unit predicts a difference between the forecast available quantity of the parts and the required quantity of the parts for the scheduled date, and automatically places an order for additional parts based upon the difference.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility.

FIG. 1 depicts a block diagram of an industrial environment in accordance with one or more embodiments of the invention.

FIG. 2 depicts an inventory management device in accordance with one or more embodiments of the invention.

FIG. 3 depicts an information flow diagram of a demand quantity prediction unit in accordance with one or more embodiments of the invention.

FIG. 4 depicts a lookup table used by an inventory management device in accordance with one or more embodiments of the invention.

FIG. 5 depicts a User Interface (UI) of an inventory management device in accordance with one or more embodiments of the invention.

FIG. 6 depicts a wellsite in accordance with one or more embodiments of the invention.

FIG. 7 depicts a flowchart of a method in accordance with one or more embodiments of the present disclosure.

### DETAILED DESCRIPTION

Specific embodiments of the disclosure will now be described in detail with reference to the accompanying figures. In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not intended to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, one or more embodiments of the invention are directed towards a demand quantity prediction unit of an inventory management device that manages the inventory of parts and products located at a manufacturer facility. As described herein, the inventory management device interlinks a manufacturer of a product to one or more suppliers of raw parts, consumers of the product, and a wellsite procedures schedule. This creates end-to-end transparency across the supply chain by merging key data sets related to demand planning, procurement, inventory, warehousing, and other logistics into a real-time intuitive and accessible platform for tracking inventory related logistics. The real time view of the supply chain allows cross-functional tracking of inventory Key Performance Indicators (KPIs), such as product and part lead times, to ensure that the parts and products are received or formed in a timely, cost-effective, and sustainable manner.

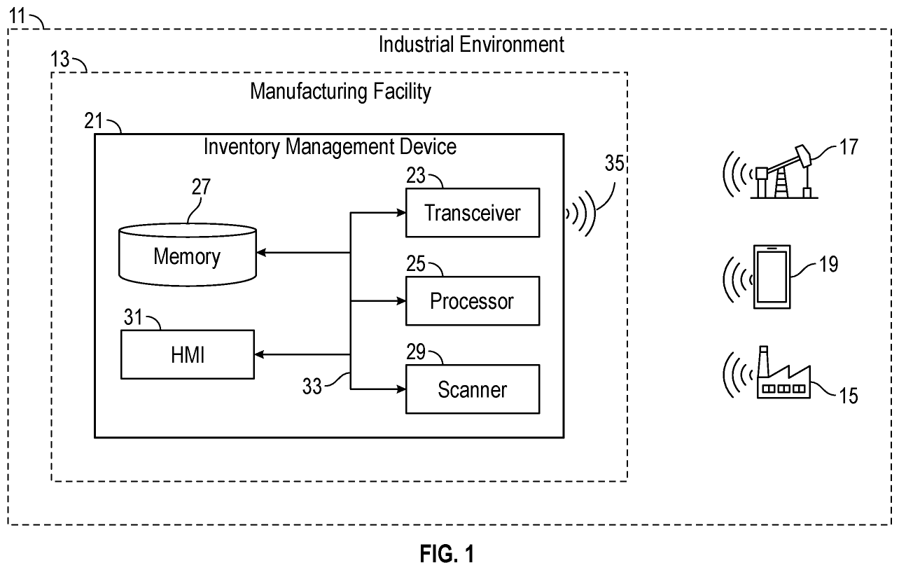

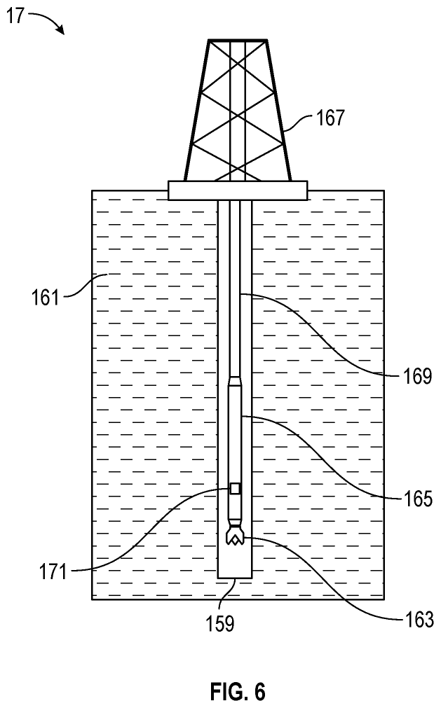

Turning to FIG. 1, FIG. 1 depicts an overview of an industrial environment 11 including an inventory management device 21 in accordance with one or more embodiments of the invention as described herein. As shown in FIG. 1, the industrial environment 11 includes a manufacturing facility 13, a supplier facility 15, a wellsite 17, and a mobile device 19. The manufacturing facility 13 is a facility that makes products for one or more wellsite procedures completed at the wellsite 17. The wellsite procedures include, for example, a process of drilling a new or existing wellbore (e.g., FIG. 6), determining a geometry, a composition, or an orientation of a wellbore, a process for determining petrophysical properties of a subterranean formation (not shown) surrounding a wellbore (not shown), well remediation procedures such as plugging a damaged or aging well, procedures for acquiring tangible goods (such as fluids) from the wellbore (not shown), or any other operation performed at the wellsite 17 during the life cycle of the wellbore. Similarly, the wellsite 17 includes a wellbore (e.g., FIG. 6) and systems and assemblies useful for creating and maintaining the wellbore, such as a drilling rig (e.g., FIG. 6) and a mud system (not shown), for example.

Continuing with the above description of the industrial environment 11, the wellsite procedures are completed with the use of a product built, assembled, or otherwise manufactured at the manufacturing facility 13. Accordingly, the products for the one or more wellsite procedures as described herein include, for example, products such as a drill bit (e.g., FIG. 6) used to extend the wellbore (e.g., FIG. 6), a plug (not shown) or Blow Out Preventer (BOP) (not shown) for closing the wellbore (e.g., FIG. 6), downhole sensors such as pressure gauges (e.g., FIG. 6) and accelerometers/gyroscopes (not shown), or equivalent devices used in downhole procedures and other wellsite procedures. The product is formed of or otherwise requires the use of one or more raw parts and materials harvested or formed by a supplier facility 15, which are shipped to the manufacturing facility 13 by way of a semi-truck, freight train, barge, or other postal vehicle. Once the raw parts and materials are received by the manufacturing facility 13, operators of the manufacturing facility 13 proceed to assemble or manufacture the products via processes such as casting, welding, brazing, adhering, lathing, or equivalent machining and tooling processes. Information concerning an available inventory of the products, as well as any parts from a supplier used to make the products, is used by the inventory management device 21 to determine if a suitable level of inventory will be available for use by the manufacturing facility 13 at the scheduled date of a wellsite procedure.

As shown in FIG. 1, the inventory management device 21 includes a transceiver 23, a processor 25, a memory 27, a scanner 29, a Human Machine Interface (HMI) 31, and a bus 33. As described herein, the transceiver 23 is formed as one or more Wi-Fi cards, Bluetooth chips, circuits, coils of wire, antennas, or data ports that respectively gather and send radiofrequency signals to and from the manufacturing facility 13, the supplier facility 15, the wellsite 17, and the mobile device 19. In this way, signals transmitted by the transceiver 23 form a wireless data connection with the wellsite 17, the mobile device 19, the supplier facility 15, and any number of additional devices (not shown), which is denoted as the data connection 35 in FIG. 1. Signals are transmitted by the transceiver 23 on frequency bands that have a frequency as low as 400 Megahertz (MHz) and as high as 71 Gigahertz (GHz). The signals received by the transceiver 23 reflect supplier inventory data specifying a number of raw parts, located at the supplier facility 15, that are used in the wellsite procedures. The supplier inventory data may be collected at the supplier facility 15, for example, by determining the amount of parts formed by the supplier facility 15, or by scanning a Stock Keeping Unit (SKU) of the parts to automatically create the supplier inventory data as described below.

Once received from the transceiver 23, the supplier inventory data is passed to a processor 25 and a memory 27. As described herein, the memory 27 comprises a non-transient storage medium such as Random Access Memory (RAM), a Hard Disk Drive (HDD), a Solid State Drive (SSD), flash memory, or equivalent storage devices. On the other hand, the processor 25 includes one or more processors, microprocessors, logic units, logic gates, controllers, microcontrollers, and/or integrated circuits that receive, process, and transmit information related to the wellsite procedures described above. The transceiver 23, the processor 25, and the memory 27 are interconnected by a bus 33 that is formed as one or more wires, Printed Circuit Boards (PCBs), optical fibers, or equivalent structures that serve to transmit electrical signals between the various components of the inventory management device 21.

As described herein, the processor 25 serves to facilitate the logistics of forming one or more products from the parts received from the supplier facility 15. To do this, the processor 25 accesses the supplier inventory information stored on the memory 27, and determines the number of products that can be built by the manufacturer based on the supplier inventory information using various modules described below. The processor 25 further accesses the memory 27 to determine the scheduled date of the wellsite procedure(s) at the wellsite 17, and determines whether the manufacturer is able to build a requisite number of products for the wellsite procedure(s) by the scheduled date. In the event that the manufacturing facility 13 is unable to build the requisite number of products, the inventory management device 21 requests additional parts and/or raw materials from the supplier. In turn, this allows additional products to be built in a time-frame prior to the scheduled wellsite procedure, which ensures that the wellsite procedure is completed on the scheduled date.

Thus, the inventory management device 21 automatically facilitates the process of managing product and part inventory for various wellsite procedures based upon the supplier inventory data. This aids in reducing the cost of the wellsite procedure overall, as the wellsite procedure is not attempted without the products and/or parts necessary to complete the procedure. The inventory management device 21 further aids in maintaining customer relations between the manufacturing facility 13 and a consumer receiving the benefits of the wellsite procedure, as the inventory management device 21 ensures that a wellsite procedure is completed by the scheduled date which increases consumer satisfaction. Moreover, real-time inventory management allows an operator of the wellsite 17 to quickly and correctly determine if a contemplated wellsite procedure may be completed, as the inventory management device 21 apprises the user, via a notification, if the wellsite procedure cannot be completed due to a lack of product and/or part inventory at the manufacturing facility 13.

Supplier inventory data and scheduling data related to the wellsite procedure that is stored on the memory 27 is visible to the supplier facility 15 and any consumers of the products by way of the transceiver 23. For example, a computing device (not shown) located at the supplier facility 15, or a mobile device 19 that is owned by a consumer, may send a request to view the supplier inventory data and/or scheduled wellsite procedures to the processor 25 of the inventory management device 21 via the transceiver 23. In such cases, the processor 25 confirms that the device is authorized to access the data (e.g., by having the user input a username and password, for example), and presents the data to the user. The data may be presented in the form of a webpage interface or User Interface (UI) as described herein that is accessed via the data connection 35, such that the data may be viewed and interacted with remotely.

Alternatively, the processor 25 may transmit a dedicated report to the user's device via the data connection 35, and the user may view the dedicated report to derive the data therefrom. Due to the data connection 35 interlinking the manufacturing facility 13 to the wellsite 17, mobile device 19, and supplier facility 15, the inventory management device 21 creates end-to-end transparency between the manufacturing facility 13 and any users directly or indirectly involved in the wellsite procedure. Such may be advantageous, for example, in a case where a product becomes damaged during the wellsite procedure, in which case an operator at the wellsite 17 can quickly determine if replacement parts or products are available for use to complete the unfinished wellsite procedure by accessing the inventory data of the entire manufacturing facility 13.

The information stored on the memory 27 may further be accessed by a Human Machine Interface (HMI) 31 of the inventory management device 21. By way of example, the HMI 31 may be embodied, for example, as a display (not shown) and associated peripheral components (not shown) such as a touchscreen, stylus, keyboard, mouse, a combination thereof, or equivalent devices. Alternatively, the HMI 31 may be embodied as a data port, such as a Universal Serial Bus (USB) port or forms thereof, a thunderbolt port, a storage card port such as a Secure Digital (SD) card port, or equivalent information transmission hubs. The HMI 31 further allows the information stored on the inventory management device 21 to be accessed by an operator located at the manufacturing facility 13, for example. Such may be beneficial, for example, in a case where an operator at the manufacturing facility 13 wishes to correct faulty or missing inventory information, where the operator uses the HMI 31 to directly access the inventory management device 21 and supplement any missing or incomplete inventory data.

Finally, the inventory management device 21 includes a scanner 29 that allows SKUs of parts and products to be scanned at the manufacturing facility 13 to determine product inventory reserves. Specifically, each part and product used during the wellsite procedure is assigned a Stock Keeping Unit (SKU), which is an alphanumeric string that uniquely identifies the part or product. The SKU is further represented by a barcode adhered to the part or product, where the lines forming the barcode are spaced apart in such a way that the spacing of the lines uniquely corresponds to a particular SKU. Thus, the scanner 29 is formed as a handheld barcode scanner, for example, that emits a laser signal and determines the distance between the lines forming the barcode based upon a laser signal reflected off of and absorbed by the barcode. Once a barcode is scanned, manufacturer inventory information specifying an amount of the products that have been built and are available for use by the manufacturer is updated. Thus, as a whole, the inventory management device 21 comprises components used to determine an inventory of raw parts and materials located at a supplier facility 15, as well as an inventory of a number of products that have been built at the manufacturing facility 13 and are available for use in the wellsite procedures.

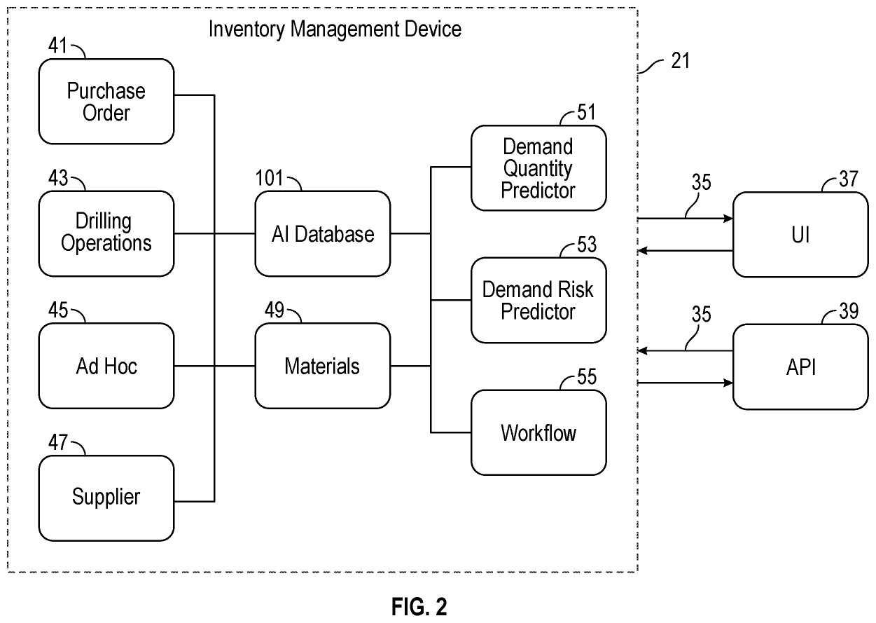

Turning to FIG. 2, FIG. 2 depicts an example of an inventory management device 21 according to one or more embodiments of the invention described herein. As discussed in relation to FIG. 1, the inventory management device 21 is accessed, by an operator, by way of a data connection 35, which may be embodied as a wired or wireless data transmission link between the inventory management device 21 and a mobile device 19, for example. More specifically, the data connection 35 may be embodied as a Wi-Fi, Bluetooth, Zigbee, Ethernet, Universal Serial Bus (USB) connection, or equivalent data transmission means known to a person of ordinary skill in the art.

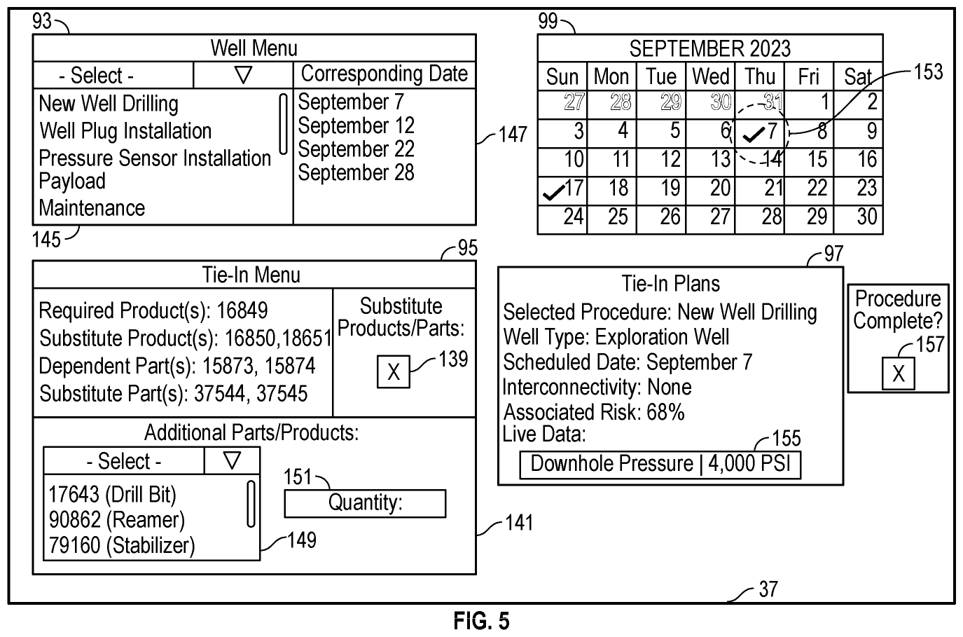

The data connection 35 is used to present a User Interface (UI) 37 to an operator, which is a series of text boxes and labels, icons, and graphical data representations that the operator interacts with in order to perform various actions with the inventory management device 21. Such graphical data representations are further described in relation to FIG. 5 and may include, for example, a virtual calendar representing a schedule of the wellsite procedures, various schematic diagrams and information of parts, products, and raw materials and goods used in the wellsite procedures, as well as any topographical, petrophysical, logistical, payload, or other forms of real-time data of the wellbore itself. The UI 37 may also be accessed by way of the HMI 31 of the inventory management device 21, which may be embodied as a keyboard, a display (including touchscreen displays), and a mouse as discussed above, for example. In this case, the computer code forming the UI 37 may be installed to the memory 27, and interpreted with the processor 25 which allows the UI 37 to be used locally at the manufacturing facility 13. Furthermore, the processing and interpretation of the UI 37 may be distributed between the inventory management device 21 and a user device, such as the mobile device 19, which is facilitated by the data connection 35 and/or the code that forms the UI 37.

The inventory management device 21 may also be accessed by the supplier facility 15 by way of an Application Programming Interface (API) 39. Similar to the UI 37, the API 39 is connected to the inventory management device 21 by way of a data connection 35, and may be installed and/or hosted on the computing components (e.g., processor, memory, etc.) of the manufacturing facility 13, the supplier facility 15, or both. As is commonly known in the art, an API is a series of one or more processes, instructions, protocols, and/or rules that allow software hosted in a first environment (such as the inventory management device 21 of the manufacturing facility 13) to communicate with software hosted in a second environment (such as inventory software owned by the supplier facility 15). The API 39 may further define communication requirements for the supplier facility 15, such as a secure connection requirement or a signal strength requirement, and may also place limitations on the amount of signal traffic processed by the data connection 35, for example. In this way, the API 39 provides an interface for the supplier facility 15 to submit supplier inventory data securely and quickly to the processor 25 and the memory 27 of the manufacturing facility 13 by way of the data connection 35, the transceiver 23, and the bus 33 as described above.

FIG. 2 further depicts the software portion of the inventory management device 21, which is formed by a series of modules executed by the processor 25 to perform various operations related to inventory management and scheduled wellsite procedures. More specifically, the series of modules include a purchase order module 41, a drilling operations module 43, an Ad-Hoc module 45, a supplier module 47, a materials module 49, a demand quantity prediction module 51, a demand risk prediction module 53, a workflow module 55, and an Artificial Intelligence (AI) database 101. The function(s) of the various modules are further discussed below. Each of the modules are formed as a series of code including algorithms, instructions, and/or operations that may be written in various computer programming languages such as Python, C++, C#, R, Java, JavaScript, and equivalent languages known to a person of ordinary skill in the art.

The purchase order module 41 manages incoming and outgoing Purchase Orders (PO) for the manufacturing facility 13. The purchase order module 41 also serves to record data on how many of the requested POs have been fulfilled and the dates of fulfillment, as well as estimated fulfillment dates for currently-unfulfilled POs determined based upon historic PO lead times further discussed below. As is commonly known in the art, purchase orders include a request for a number of parts to be sent from a first party to a second party as part of a monetary interaction. For example, a PO may reflect a request for additional parts to be shipped from a supplier facility 15 to a manufacturing facility 13, or a request for the manufacturing facility 13 to ship products to a third-party consumer (not shown). In addition, the purchase order module 41 also stores invoices associated with completed purchase orders (in the form of timestamped SKU data), which aids in managing budgeting and accounting related logistics. In the event that any of the products are returned to the manufacturing facility 13 after a PO is completed, the purchase order module 41 edits the inventory data to reflect the updated inventory of products. This allows the inventory management device 21 to be informed on the inventory logistics related to the wellsite procedures as a whole, which in turn allows the inventory management device 21 to report on or revise any wellsite procedures as further discussed below.

The drilling operations module 43 stores, receives, and/or determines scheduling data for the various wellsite procedures described herein. The scheduling data includes, for example, a scheduled date of the wellsite procedures and a requisite quantity of the products built by the manufacturer to be used during the wellsite procedures, which is received from the materials module 49. Scheduling data is provided to the operator and stored on the memory 27 in the form of well menus, tie-in plans, and tie-in menus, as discussed below and further discussed in relation to FIG. 5. The well menus include each type of drilling operation that can be performed as part of the wellsite procedures, and are presented to the user as a drop-down menu, hamburger menu, or equivalent graphic format in the UI 37. The well menus further include a drop down menu of dates at which the wellsite procedure may be completed, which are determined as a function of the availability of the products and an availability of well operators.

Similarly, the tie-in plans are information presented to the operator, as a text box, depicting types and locations of wells that are scheduled to be dilled over the coming years, as well as any connections to existing wells (e.g., tunnels between wellbores, if a particular wellbore is sharing a wellsite with other wellbores, common parts or structures shared between wellbores, etc.). The tie-in menus, on the other hand, include selection menus (such as a drop-down or hamburger menu, or drag-and-drop list) where an operator can add to or edit a bill of materials that includes parts, products, devices, tools, etc. for use in a wellsite procedure, and can select various operations to be completed as part of the wellsite procedure.

For illustrative and exemplary purposes only, in a case where a wellsite procedure involves drilling a series of wellbores, the scheduling data includes a date or series of dates at which the wellbores are to be drilled, which is selected with the well menu, as well as an estimated number of drill bits (i.e., the requisite quantity of products) necessary to drill the wellbores. In this case, the requisite quantity of products is determined by the materials module 49 and returned to the drilling operations module 43, as further described below. As a second example, the inventory management device 21 may be used for a well abandonment procedure, where the requisite quantity of products includes a number of downhole devices, such as a cement plug and associated plugging components, selected with the tie-in menu, and the scheduled date is the date at which a wellbore is to be sealed with the cement plug selected with the well menu.

The Ad-Hoc module 45 allows guest users limited access to inventory data stored by the inventory management device 21. As noted above, operators and/or suppliers access the inventory data by inputting a username and password into the UI 37 and/or API 39, or a similar user verification process such as dual-factor authentication, security keys, or via security cards emitting a radio-frequency unique to a specific user. However, cases may exist where the manufacturing facility 13 desires to temporarily allow access to the inventory management device 21 to a limited number of users. For example, a systems engineer may wish to present PO and inventory data to a well operator, or a manufacturing facility 13 may wish to share its data with regulatory authorities such as a local government for legal purposes. In such cases, the Ad-Hoc module 45 provides a simple, configurable user interface that allows the inventory management device 21 to share limited amounts of information with the third-party user.

To enable the above functionality, the Ad-Hoc module 45 presents a dedicated UI to the third-party user, with limited access to specific modules deemed necessary by the manufacturing facility 13 or other responsible authority. The dedicated UI may be displayed to an external device such as the mobile device 19, or a local device such as the HMI 31, for example. As one example of the functionality of the Ad-Hoc module 45, the Ad-Hoc module 45 may be preconfigured with various user profiles that have limited access to different modules of the inventory management device 21. For example, the Ad-Hoc module 45 may be configured with a “financial” profile that has access restricted to only the data processed by the purchase order module 41, or an “inventory” profile that has access restricted to only the inventory related data of the inventory management device 21. The Ad-Hoc module 45 may further give the profiles varying levels of read and write access, such that a first, unsecured profile may only “read” (i.e., not edit) data, and a second profile, that is securely protected, may “write” (i.e., edit) data of the various modules. In this way, the Ad-Hoc module 45 allows third party users to easily access and view all data processed by the inventory management device 21 according to the discretion of the manufacturing facility 13.

Continuing with FIG. 2, while the API 39 is used to transmit supplier inventory data from the supplier facility 15 to the manufacturing facility 13 and inventory management device 21, the supplier module 47 provides a supplier facility 15 with dedicated access to the data of the inventory management device 21. Similar to the Ad-Hoc module 45, the supplier module 47 may limit the ability of the supplier facility 15 to access various modules of the inventory management device 21 to prevent a supplier facility 15 from accessing data that the manufacturing facility 13 wishes to keep secret. For example, if the supplier facility 15 is a competitor of the manufacturing facility 13, the manufacturing facility 13 may wish to keep PO data provided by the purchase order module 41 secret from the supplier facility 15 in order to avoid the supplier facility 15 from gaining a competitive advantage. The supplier module 47 is embodied, accordingly, as a dedicated interface that is presented to personnel of the supplier facility 15.

The supplier module 47 also provides communication features for the manufacturing facility 13 and the supplier facility 15. Such communication features include, for example, a chat service that allows suppliers to contact the manufacturer and vice versa, and online forms (such as POs) that the supplier and manufacturer can use to request/fulfil part orders. Further examples of communication features include automatic label generators that generate shipping labels for part to be shipped to a supplier facility 15, as well as return label generators. As an additional example, the dedicated interface generated by the supplier module 47 may include an automatically updated list of POs that a supplier is supposed to fulfil, and information (such as lead times) concerning previously fulfilled POs. As a result, the supplier module 47 eases the logistics of sending parts from a supplier facility 15 to a manufacturing facility 13, and further facilitates communication therebetween.

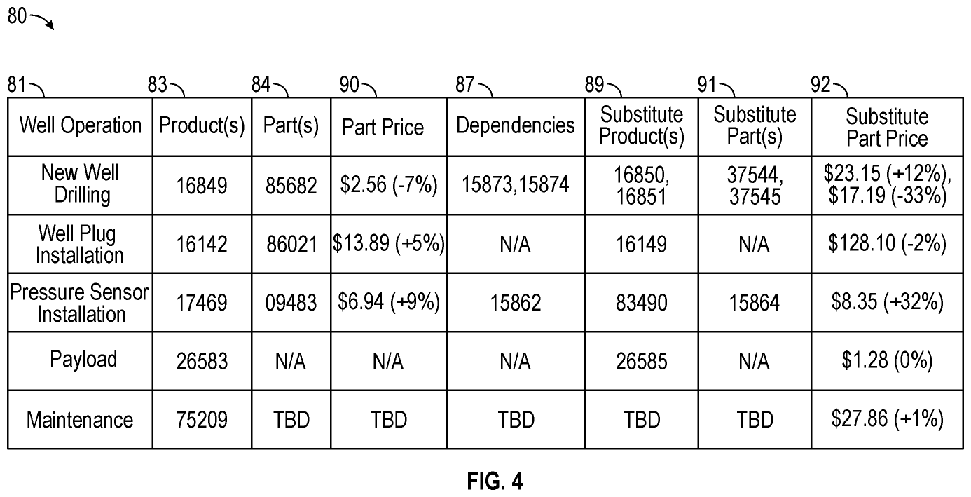

The materials module 49 stores construction information that specifies a requisite number of parts, supplied by a supplier facility 13, that are necessary for the manufacturing facility 13 to build products for the wellsite procedures. As noted above, the particular wellsite procedure is selected with the drilling operations module 43. Once a particular wellsite procedure is selected, the drilling operations module 43 accesses the materials module 49, which returns a number of products required to complete the wellsite procedure, as well as any parts needed to build or assemble the product. The data specifying the requisite parts and products used in wellsite procedures is further described in relation to FIG. 4, and is stored as a lookup table on the memory 27 such that the materials module 49 performs a lookup function on the data to determine the products and parts associated with the selected wellsite procedure. The data further includes any dependency information of parts that must be used together, such as if a first part requires the use of a second part to complete a wellsite procedure or form a product. The requisite products and any parts used to build the products are then presented to the user in the bill of materials output by the drilling operations module 43, and used to forecast an available quantity of products as further discussed below.

In addition to storing information regarding the requisite parts used by the manufacturing facility 13 to build a particular product, the materials module 49 further stores substitute data specifying part interchangeability as part of the construction information. Specifically, the substitute data specifies components from a second supplier, or additional parts from the supplier facility 15, that are interchangeable with the requisite parts. In the event that the requisite parts required to build a product are unavailable, the materials module 49 may return the substitute data to the drilling operations module 43, and flag the output in the tie-in menu such that the operator is aware that the wellsite procedure may need to be completed with substitute parts. In this way, the materials module 49 is able to work in tandem with the drilling operations module 43 to ensure that a wellsite procedure is completed in a timely fashion with products formed of the substitute parts. If a user of the inventory management device 21 does not desire to use the substitute data, the drilling operations module 43 provides an option to disable the substitute data in the tie-in menu (e.g., FIG. 5), which prevents the materials module 49 from returning or using the substitute data.

The materials module 49 is further configured to store cost information of all parts and products as part of the lookup table. The cost information includes the current cost of a part or product, as well as a historical price thereof and a percentage change of the cost as a function of its historical price. This allows the bill of materials output by the drilling operations module 43 to include pricing information for the entire wellsite procedure. In turn, the cost information may, for example, be used by the operator to ensure that a particular wellsite procedure is within budgeting constraints imposed by a managing entity of the manufacturing facility 13. Furthermore, the cost information allows the materials module 49 to perform spend optimization functions by comparing the cost of the requisite parts to the cost of the substitute parts. In the event that the substitute parts have a lower cost than the requisite parts, the materials module 49 outputs the substitute parts, with a user alert flag reflecting the substitution, to the drilling operations module 43. In this way, the date and cost of wellsite procedures scheduled with the drilling operations module 43 are automatically optimized to the specific desires of a user.

Existing inventory information is captured for the inventory management device 21 by way of the workflow module 55. In particular, the workflow module 55 receives information via the transceiver 23 concerning the supplier inventory data specifying the parts used in the wellsite procedures from the supplier facility 15. In addition, the workflow module 55 stores the amount of resources available to form the products at the manufacturing facility 13, which may include data such as the amount and schedule of the collective manual labor hours operators are expected to complete at the manufacturing facility 13, for example. The workflow module 55 also stores granular data related to each step of a process for assembling products at the manufacturing facility 13, as well as the estimated time to complete the assembly, such that the workflow module 55 includes data related to the assembly status of each product at the manufacturing facility 13.

The workflow module 55 also interfaces with the one or more scanners 29 in the manufacturing facility 13, which are used to scan SKUs of the products as they are built and the parts as they are received. The inventory data captured by the workflow module 55 is transmitted to the materials module 49, which is further input into an AI database 101 by a demand quantity prediction module 51 as described below. The workflow module 55 is also configured to capture time-series data specifying when the products are created and the parts are received, by virtue of recording the time that a specific product or part is scanned.

To facilitate forecasting of the future availability of parts and products, the inventory management device 21 includes a demand quantity prediction module 51. The demand quantity prediction module 51 may be embodied, for example, as an Artificial Intelligence (AI) model that uses algorithms such as boosted trees, logical regression, or random trees, for example, to develop a forecast quantity of products available for the wellsite procedure. The algorithms enable the AI to learn about and form relationships between the data captured with the various modules described above. In particular, based upon the construction information captured by the materials module 49, the product and part data received by the workflow module 55, and the scheduling data gathered by the drilling operations module 43, the demand quantity prediction module 51 determines if the products are being built at an acceptable rate. For exemplary purposes, the acceptable rate is a rate such that a requisite number of products are forecast to be built by the supplier facility 15 and available for use prior to the scheduled date of the wellsite procedure(s). The above described forecast quantity of available products is transmitted to the drilling operations module 43, which may request additional parts from a supplier facility 15 based thereon using the purchase order module 41 as described above.

However, the process of forecasting a quantity of available products for the wellsite procedures is necessarily dependent upon a margin of error and a measure of risk assumed by the manufacturing facility 13. For example, a supplier facility 15 may be unable to fulfill one or more POs due to a natural disaster, or the manufacturing facility 13 may experience downtime due to unexpected repairs. To reflect this inherent risk, the inventory management device 21 further includes a demand risk prediction module 53 that determines the risk associated with a particular wellsite procedure as a function of the supplier inventory data and manufacturer inventory data. Similar to the demand quantity prediction module 51, the demand risk prediction module 53 is an AI model that uses algorithms such as boosted trees, logical regression, random trees, or equivalent learning models known to a person of ordinary skill in the art.

More specifically, the risk prediction is determined by the demand risk prediction module 53 as a function of the previous POs stored by the purchase order module 41, supplier inventory information from the supplier module 47, manufacturer inventory information supplied by the workflow module 55, and scheduling data provided by the drilling operations module 43. The demand risk prediction module 53 predicts the risk by assigning weights to each of the aforementioned data, based upon the inherent level of risk associated with the type of data, and forming relationships between the weighted data with the aforementioned algorithms. For example, the demand risk prediction module 53 may determine that the manufacturing facility 13 has not formed enough products to complete a wellsite procedure, and assigns a low weight to the contemplated wellsite procedure. On the other hand, if the demand risk prediction module 53 receives inventory data indicating that a large number of products are currently available for use, the demand risk prediction module 53 assigns a relatively low weight to the wellsite procedure. Based upon a relationship formed between the various determined weights (e.g., the relationship formed with the algorithms described above) which range from 0-1, the demand risk prediction module 53 determines an overall level of risk for each particular wellsite procedure. The determined weights and the overall level of risk as described herein range from 0-1, or may be expressed as a decimal number. This process is further discussed below.

The level of risk is further output to the operator by way of the tie-in information presented by the drilling operations module 43 on the UI 37, which allows the operator to manually determine if a wellsite procedure has a high likelihood of not being completed. Furthermore, if the demand risk prediction module 53 determines that a wellsite procedure has an overall level of risk above a predetermined amount, the demand risk prediction module 53 directs the purchase order module 41 to submit a PO for additional parts from the supplier facility 15, and directs the workflow module 55 to increase the number of manual labor hours of the manufacturing facility 13 such that additional products are produced prior to the scheduled date of the wellsite procedure.

To store and determine values with the Artificial Intelligence (AI) algorithms described herein, which are computed with the demand quantity prediction module 51 and the demand risk prediction module 53 as described above, the inventory management device 21 further includes an AI database 101. The AI database 101 is connected to each of the other various modules of the inventory management device 21, such that the drilling operations module 43 and materials module 49 may input inventory data and/or PO data into the AI database 101 that is subsequently used by the demand quantity prediction module 51 and the demand risk prediction module 53 as described above. As discussed below, one example of an AI database 101 is depicted as Table 1, which stores the information received and determined by the inventory management device 21 in relation to the contemplated wellsite procedure.

Thus, overall, the series of modules that forms the inventory management device 21 allow logistics related to managing the inventory of products and/or parts required to complete a wellsite procedure to be automatically managed according to the inherent risk and logistical requirements for attempting a wellsite procedure. The series of modules forming the inventory management device 21 further facilitate visibility into the entire supply chain of the wellsite procedure by allowing authorized personnel a transparent view of the real-time logistics and risks associated with the wellsite procedure by way of the user interface 37. Advantageously, this allows a wellsite procedure to be completed in a low-cost and timely manner by ensuring that the products required to complete the wellsite procedure are available for use prior to the scheduled date thereof.

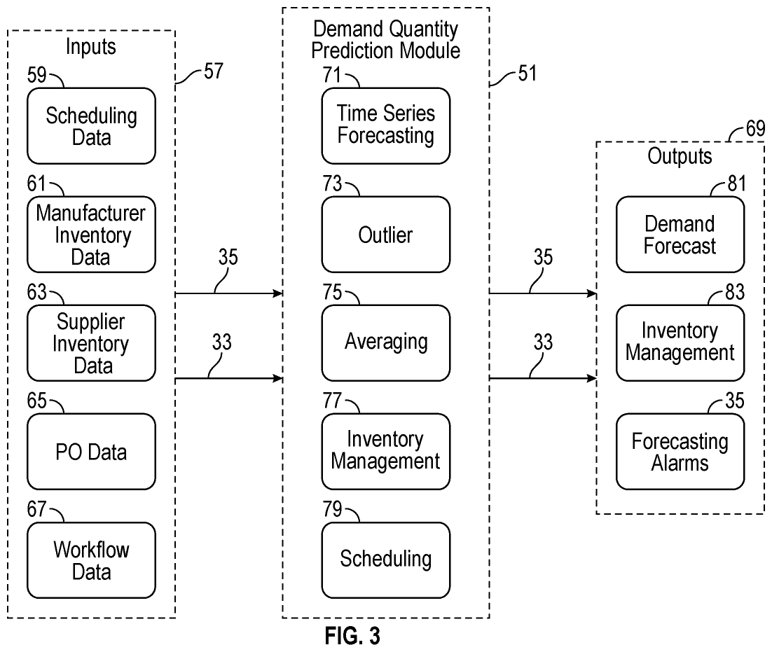

Turning to FIG. 3, FIG. 3 depicts an information flow diagram representing the information processing completed by a demand quantity prediction module 51 consistent with one or more embodiments of the invention as described herein. Specifically, FIG. 3 depicts a series of inputs 57 and outputs 69 of the inventory management device 21. The inputs 57 include various forms of data as described above, such as manufacturer inventory data 61, Purchase Order (PO) data 65, workflow data 67, supplier inventory data 63, and scheduling data 59. The manufacturer inventory data 61 and the supplier inventory data 63 are generated by scanning barcodes of Stock Keeping Units (SKUs) of various products and parts created or assembled by the manufacturing facility 13 and supplier facility 15, respectively. The scanning process may be facilitated with a scanner 29 located at one or both of the manufacturing facility 13 and the supplier facility 15, for example. On the other hand, the PO data 65 reflects historical and current quantities of the parts and/or products purchased by the manufacturing facility 13, the supplier facility 15, or a third party, which is input into the inventory management device 21 by way of the well menu of the drilling operations module 43 as described above.

Similarly, the workflow data 67 details the day-to-day inflow and outflow of parts and products from the manufacturing facility 13, and further reflects a number of products that are currently being built or assembled by operators located at the manufacturing facility 13. The scheduling data 59 includes a scheduled date for a particular wellsite procedure or series of wellsite procedures. The scheduling data 59 further includes map data detailing available and scheduled locations of wellsite procedures, which are used to determine if additional wells may be drilled at the wellsite 17 in the event of a well failure, such as a dry well that does not produce a payload. In this way, the inventory management device 21 is provided with multiple sources of data as its inputs 57 that are used to ultimately determine if a wellsite procedure may be completed in a timely manner.

Once captured, inputs 57 are transmitted to the inventory management device 21 by way of the data connection 35 and/or the bus 33 as described above. More specifically, data (e.g., workflow data 67) captured at the manufacturing facility 13 is directly transferred to the inventory management device 21 by way of the bus 33. On the other hand, data captured by the supplier facility 15, such as the supplier inventory data 63, is transferred to the inventory management device 21 by way of the bus 33 and the transceiver 23 as described above.

As depicted in FIG. 3, the demand quantity prediction module 51 includes a series of modules that serve to process the inputs 57 and generate outputs 69. To this end, the demand quantity prediction module 51 includes a time-series forecasting module 71, an outlier module 73, an averaging module 75, an inventory management module 77, and a scheduling module 79. The functionality of the various modules that form the demand quantity prediction module 51 is further discussed below. Each of the modules and any data processed thereby may be stored on a memory 27, for example, or may be hosted on a cloud server (not shown) that communicates with the inventory management device 21 by way of the data connection 35.

The time-series forecasting module 71 receives existing inventory information from the workflow module 55, and adds the existing inventory information to an AI database 101 (e.g., Table 1 discussed below) comprising previous inventory information. The existing inventory information is captured using a scanner 29 of the manufacturing facility 13 by the workflow module 55, for example, or generated by the workflow module 55 based upon the scheduling data 59 and the manufacturer inventory data 61 as discussed above. Thus, the existing inventory information reflects the amount of products, parts, and raw materials available at a manufacturing facility 13. In addition, the time-series forecasting module 71 is further configured to add the supplier inventory data 63 to the AI database 101 once received by the workflow module 55, such that the AI database 101 reflects the inventory of raw materials, goods, and parts at the supplier facility 15. Once all of the inventory data has been added to the AI database 101, the AI database 101 includes time-series data related to the historical inventory available for use by the manufacturing facility 13.

As a function of forming the AI database 101, the time-series forecasting module 71 is further configured to periodically update the AI database 101 with new inventory information as the information becomes available. To do this, the demand quantity prediction module 51 receives the new supplier inventory information from the workflow module 55, and the time-series forecasting module 71 inserts the new data into the AI database 101 with its corresponding timestamp. As noted above, the AI database 101 is stored on the memory 27, but may alternatively be hosted on any storage device of the industrial environment 11, such as a cloud server (not shown) that communicates with the inventory management device 21 by way of the data connection 35. Thus, overall, the AI database 101 includes previous and current supplier and manufacturer inventory data, as well as other information related to the wellsite procedure.

However, the AI database 101 may include errant, outlying, or otherwise statistically abnormal inventory information generated during the process of forming the products. Such statistically abnormal data may include, for example, inventory information related to a period of time where an operator errantly scans a part or product multiple times, in which case the inventory information reflects an abnormally high available inventory of products for use in the wellsite procedure. In such cases, an outlier module 73 of the demand quantity prediction module 51 performs a filtering operation to filter out the errant data. The filtering operation includes, for example, deleting data from the AI database 101 that is less than a first predetermined quantity (e.g., a minimum inventory reserve) of materials, parts, and/or products, which reflects situations where a manufacturing facility 13 possesses an abnormally low product, part, and/or material inventory. The filtering operation further includes, for example, deleting data from the AI database 101 that is greater than a second predetermined quantity of materials, parts, and/or products, which reflects situations where a manufacturing facility 13 possesses a large unused inventory of products, parts, and/or materials. In this way, the AI database 101 is updated, in real time, to reflect filtered time-series data related to the current inventory of parts and products. The filtered nature of the time-series data further ensures that the demand quantity prediction module 51 does not incorrectly forecast the available quantity of products from being influenced by the abnormal inventory data, as the AI database 101 only includes data related to the typical functioning of the manufacturing facility 13 and the supplier facility 15.

Continuing with FIG. 3, the demand quantity prediction module 51 further includes a scheduling module 79 that receives and stores a required quantity of products for use in the wellsite procedure at the scheduled date. As discussed above, the required quantity of products is initially determined as a joint effort between the drilling operations module 43 and the materials module 49, where an operator selects a wellsite procedure via the drilling operations module 43 and the materials module 49 returns the required parts and products necessary to complete the selected wellsite procedure. Thus, the scheduling module 79 is configured to request or automatically retrieve the required products from the lookup table utilized by the materials module 49 according to a selected wellsite procedure received from the drilling operations module 43. As is further discussed below, the quantity of required parts is ultimately used by the demand quantity prediction module 51 to determine if additional parts are necessary to complete the wellsite procedure.

The demand quantity prediction module 51 also includes an averaging module 75, which serves to compute a moving average of the filtered time-series inventory data to create average inventory data. As discussed above, the filtered time-series inventory data is formed as an AI database 101 comprising a series of coalesced timestamped supplier and manufacturer inventory data points, which are input by the workflow module 55. Thus, the averaging module 75 computes the moving average of the filtered time-series inventory data by summing multiple timestamped inventory data points for a predetermined period of time, and dividing the summation by the number of inventory data points. After repeating this process for multiple time periods, the averaging module 75 creates a series of moving averages for the filtered time-series data, which relate to the typical number of parts, products, or materials received, formed, or assembled at the manufacturing facility 13 for that period of time. As discussed below, the moving averages are subsequently used by the averaging module 75 as lead times associated with the products and parts.

Based upon the moving average(s), the time-series forecasting module 71 determines a forecast quantity of products for use at the scheduled date. More specifically, the time-series forecasting module 71 uses one or more algorithms described herein that form an AI model that determines relationships between the production rates and the remaining time prior to the scheduled date of the wellsite procedure. For example, the time-series forecasting module 71 may employ a boosted trees algorithm that relates the historical production rates to the remaining time before the wellsite procedure to determine a forecast quantity of built parts or products, and subtracts parts or products from the forecast quantity based upon other scheduled wellsite procedures to determine the forecast available quantity of parts and/or products for use in the wellsite procedure.

The AI model utilized by the time-series forecasting module 71 may further consider additional parameters while determining the forecast available quantity of parts and/or products. Such additional parameters may include, for example, a likelihood that additional parts and/or products will need to be used in the scheduled wellsite procedure or other wellsite procedures, which may be determined based upon an inherent risk of a part or product failing during the wellsite procedures. As a second example, the demand quantity prediction module 51 may consider that additional wellsite procedures that have not yet been scheduled may need to be completed prior to the scheduled wellsite procedures, and decrease the amount of available parts and/or products for the scheduled wellsite procedure to reflect inventory reserves for the additional wellsite procedures. Thus, overall, the time-series forecasting module 71 of the demand quantity prediction module 51 and its constituent AI model may consider multiple sources of data during the process of forecasting an available quantity of parts and/or products for use in the wellsite procedure. This process is further discussed below.

Finally, the demand quantity prediction module 51 also includes an inventory management module 77 that predicts a difference between the forecast available quantity of the parts/products and the required quantity of the parts/products for the scheduled date. The difference may be computed, for example, using a subtraction operation that subtracts the previously computed forecast available quantity from the required quantity. Alternatively, the difference may be computed as a function of the multiple parameters described above, where the AI model employed by the demand quantity prediction module 51 forms relationships between the multiple parameters. For example, the difference may be computed to account for minimum inventory reserves set by the manufacturing facility 13 itself, or to account for unscheduled wellsite procedures as described above.

Based upon this difference, the inventory management module 77 submits Purchase Orders (POs) requesting additional parts from a supplier facility 15. In particular, when the inventory management module 77 determines that the forecast available quantity of parts and/or products is less than the required quantity of parts and/or products, the inventory management module 77 instructs the purchase order module 41 to fill out and submit a PO requesting a quantity of parts from the supplier facility 15 that corresponds to the determined difference. In this way, the inventory management module 77 ensures that POs are automatically submitted in a timely fashion such that the supplier facility 15 is provided with enough time to fulfill the PO. More specifically, because the forecasting operation of the inventory management module 77 occurs immediately following the selection of a wellsite procedure with the drilling operations module 43, any POs are submitted by the purchase order module 41 at the behest of the inventory management module 77 at the earliest possible time to allow the supplier facility 15 a maximum amount of time possible to fulfill the PO.

The inventory management module 77 is further configured to notify a supplier facility 15 in the event that a PO is incorrectly fulfilled. Particularly, and as noted above, the demand quantity prediction module 51 receives new inventory data concerning a number of parts received from the supplier facility 15, which is captured with one or more scanners 29 when the manufacturing facility 13 receives the parts as described above. Once the inventory management module 77 has received the new inventory data, the inventory management module 77 accesses the PO data 65 to determine if the new inventory data matches the number of parts requested in the corresponding PO. If the new inventory data is less than the number of requested parts (e.g., a supplier mistakenly did not include parts in a shipment), then the inventory management module 77 proceeds to submit an additional PO, via the purchase order module 41, to the supplier facility 15. In turn, this allows the inventory management device 21 as a whole to notify the supplier facility that the shipment of parts was deficient and request additional parts when the quantity of received parts is less than the quantity of requested parts.

The outputs 69 depicted in FIG. 3 represent various real world actions that result from the various inventory-related computations performed by the demand quantity prediction module 51 described above. While any number of outputs 69 may result from using the demand quantity prediction module 51, the outputs 69 depicted in FIG. 3 are representative of exemplary scenarios in which the workflow module 55 plays a substantial role in completing a scheduled wellsite procedure. As described herein, the outputs 69 include demand forecasting operations 81, inventory management operations 83, and forecasting alarms 85.

Demand forecasting operations 81 are operations performed to forecast the amount of demand for a particular part or product, and actions taken in relation to the forecast. For example, using the PO data 65, which comprises, in part, future POs for required parts and products, the demand quantity prediction module 51 determines that there is a high demand for the required part based upon the repeated scheduled use of the part in multiple wellsite procedures. In this case, the demand quantity prediction module 51 submits additional POs requesting more parts, and may further increase the minimum inventory reserve of the part described above to account for the repeated part use. In this way, the demand forecasting operations 81 are operations performed using the forecast demand for a part or product, which ensures that the manufacturing facility 13 as a whole is always in possession of the amount of parts and products necessary to complete a contemplated wellsite procedure.

Similarly, inventory management operations 83 include actions taken by the demand quantity prediction module 51 based upon the current part and product inventory possessed by the manufacturing facility 13. For example, in a case where available inventory data is larger than a predetermined maximum inventory reserve, the demand quantity prediction module 51 will decrease the manual labor hours scheduled to be worked at the manufacturing facility 13 by way of the workflow module 55. In turn, this ensures that the production rate of the manufacturing facility 13 decreases, requiring the use of the excess inventory to complete any wellsite procedures. Similarly, if the current part and/or product inventory falls below a predetermined amount, the demand quantity prediction module 51 directs the purchase order module 41 to submit additional POs to a supplier facility 15 to increase the part and product inventory reserves. As a third example, a case may exist where the demand quantity prediction module 51 determines from the supplier inventory data 63 and the manufacturer inventory data 61 that the manufacturing facility 13 has a large number of parts from the supplier facility 15 that have not been used to build products. In this case, the demand quantity prediction module 51 directs the workflow module 55 to increase the amount of scheduled manual labor hours for the manufacturing facility 13, which causes the parts located at the manufacturing facility 13 to be transformed into products. Thus, the inventory management operations 83 includes operations taken by the demand quantity prediction module 51 based upon the current inventory levels of parts and/or products located at the manufacturing facility 13 and the supplier facility 15.

Forecasting alarms 85 relates to notifying operations taken by the demand quantity prediction module 51 to alert operators to proposed or required changes to a wellsite procedure. For example, in a case where a wellsite procedure requires the use of substitute parts based upon a lack of supplier inventory, the demand quantity prediction module 51 directs the drilling operations module 43 to output a flag to the operator, via the tie-in menu (e.g., FIG. 5), that notifies the operator that the wellsite procedure is to be completed with the substitute parts. Similarly, in a case where the demand quantity prediction module 51 submits POs for additional parts based upon the forecast quantity of products being less than a required quantity of products, the demand quantity prediction module 51 alerts an operator or managing entity of the manufacturing facility 13 that additional POs have been submitted. Thus, the forecasting alarms 85 depicted in FIG. 3 represent the various ways that an operator is informed of wellsite procedure logistics based upon operations performed by the demand quantity prediction module 51.

Overall, the inventory management device 21, and particularly the demand quantity prediction module 51, affect the wellsite procedure by automatically controlling the logistics of the wellsite procedure and managing inventory levels associated therewith. Advantageously, this ensures that the wellsite procedure is completed by the scheduled date, as the demand quantity prediction module 51 prevents logistical impediments (i.e., low part and/or product inventory reserves) to the wellsite procedure.

Turning to FIG. 4, FIG. 4 depicts an example of a lookup table 80 that is searched by the materials module 49 to determine the required product(s) and part(s) needed to complete a particular wellsite procedure. As discussed above, the lookup table 80 may be stored, for example, on the memory 27, or stored on a remote data server (not shown) that is accessed with a wireless data connection (e.g., data connection 35). The lookup table 80 includes information that associates each potential wellsite procedure with the components necessary to complete the operation, such that the lookup table 80 forms the construction information described above. The information of the lookup table 80 may be manually input by an operator via the materials module 49 and HMI 31, for example, or preconfigured by a manufacturer of the inventory management device 21 via the materials module 49.

As depicted in FIG. 4, the lookup table 80 is formed as a series of rows and columns. The rows correspond to various wellsite procedures that may be performed, while the columns relate to the products and parts associated with the particular wellsite procedure. Thus, the first column of the lookup table 80 is operation information 82 that lists each wellsite procedure that may be completed. Thus, in the example depicted in FIG. 4, the operation information 82 includes procedures such as, but not limited to, a new well drilling procedure, a well plug installation procedure, a pressure sensor installation procedure, a payload procedure, a maintenance procedure, or equivalent procedures known to a person of ordinary skill in the art. By way of example, a new well drilling procedure may be a procedure to drill an exploratory well at a test wellsite (e.g., FIG. 6). On the other hand, well plug installation and pressure sensor installation procedures relate to setting up additional devices, such as a cement plug for sealing a wellbore, or a downhole pressure sensor (e.g., FIG. 6) that measures the internal pressure of an existing wellbore. Similarly, a payload procedure includes procedures related to acquiring crude oils, gases, and other tangible commodities trapped at a wellsite 17. Finally, a maintenance procedure takes the form of an operation to replace failed or damaged parts at a wellsite 17.

Continuing with the examples presented above, the second column of the lookup table 80 corresponds to product information 84 of product(s) that are used in the particular wellsite procedure. The product(s) are stored in the product information 84 column as a series of one or more Stock Keeping Units (SKUs) that uniquely identify the product(s) as described above. The SKUs may be input by the manufacturing facility, or retrieved from a remote global database of SKUs via the transceiver 23, for example.

As discussed above, products used for the process of drilling a new wellbore may include, for example, drill bits (e.g., FIG. 6), reamers, and stabilizers that are attached to a drilling rig. Thus, SKU 16849, which is depicted in the uppermost cell of the second column of the lookup table 80, identifies the particular drill bit, reamer, or stabilizer used in the drilling operation. Similarly, SKU 16142 corresponds to a well plug and SKU 17469 corresponds to a pressure sensor that may be installed at the wellbore during an installation operation. Furthermore, because the payload operation may include operations such as drilling a new section of an existing wellbore, SKU 26583 corresponds to a second size of drill bit (i.e., a drill bit with a different SKU than the drill bit used to drill a new well) used to drill the section of wellbore. Finally, SKU 75209 demonstrates, for example, an SKU of diagnostic equipment used at the wellsite 17 to determine any faults in parts or products used in the wellsite procedure.

Similar to the product information 84, the third column of the lookup table 80 includes part information 86 that specifies any part(s) from a supplier facility 15 that are required to complete a particular wellsite procedure. Thus, and continuing with the examples above, an SKU of 85682 in the part information 86 represents, for example, parts such as a section of a drill string that supports the drill bit(s), stabilizer(s) and reamer(s) identified by SKU 16849 depicted in the product information 84. An SKU 76021 in the part information 86 may represent, for example, a bushing of a well plug identified by SKU 16142, while the SKU 09483 corresponds to a wiring harness that is attached to the pressure sensor identified by SKU 17469. The cells that correspond to the “payload” and “maintenance” operations are respectively labeled as “N/A” (Not Applicable) and “TBD” (To Be Determined). The label “N/A” represents that no additional parts are required from a supplier facility 15 to complete a payload operation. On the other hand, the label “TBD” indicates that additional SKUs will be written to the part information 86 based upon the results of the maintenance operation. As the maintenance operation is in the process of being completed, the value of the cell updates periodically to indicate that no additional parts are necessary (“N/A), to indicate the SKU of any required parts that are to be replaced, or to reflect that the diagnostic portion of the maintenance operation has not yet been completed (TBD).

In addition, the fourth column of the lookup table 80 stores price information 90 of the parts stored in the product information column 84. Specifically, the price of each part is extracted from the PO corresponding to the part by the purchase order module 41, which includes the time that a part was received, the quantity of received part(s), and the cost thereof. The purchase order module 41 then proceeds to input this priced information into the price information 90 column. As additional POs are received for additional part shipments, the purchase order module 41 further determines the change in price from the last shipment to the current shipment, and stores this difference as a percentage in the price information 90. Thus, as depicted in FIG. 4, the uppermost cell of the price information 90 has a value of “$2.56 (−7%)”, which describes that the current cost of a part with SKU 85682 is $2.56, which is a 7% decrease from the previous shipment cost per part.

While the product information 84 and part information 86 columns describe the required products and parts needed to complete a particular wellsite procedure, the dependency information 87 captured in the fifth column of the lookup table 80 reflects any dependent products or parts necessary to use the products and parts of the product information 84 and the part information 86 columns. For example, and as described above, the well drilling procedure requires the use of a product with SKU 16849 (e.g., a drill bit), and a part with SKU 85682 (e.g., a drill string section). Thus, the dependent parts and/or products have SKUs of 15873 and 15874, which identify parts such as a Bottom Hole Assembly (BHA) and a drill collar that are used in conjunction with the drill bit and drill string section (e.g., the required products and parts for the wellsite procedure). As there are no dependent parts required for the well plug installation procedure and the payload procedures, these cells read “N/A”. Furthermore, the pressure sensor installation procedure has a dependent product/part with an SKU of 15862, which identifies a component such as a power source (e.g., a battery) or a casing assembly for the pressure sensor with an SKU of 17469. Finally, the cell of the dependency information 87 corresponding to the maintenance operation reads “TBD” to indicate that additional product and part SKUs will be added based upon the diagnosis of the failing products and/or parts at the wellsite 17.

However, cases may exist where substitute products and parts are used during the wellsite procedure. For example, and as described above, a manufacturing facility 13 may not be able to produce enough drill bits (e.g., identified by SKU 16849) to complete a new well drilling operation. In this case, the lookup table 80 includes substitute data in the form of substitute product information 89 and substitute part information 91, which form the sixth and seventh columns of the lookup table 80, respectively. More specifically, the substitute product information 89 includes a list of SKUs of products that are interchangeable with the products reflected by the product information 84. Similarly, the substitute part information 91 includes a list of any parts produced by the supplier facility 15 that are interchangeable with parts from the part information 86. In the event that any of the products and parts in the dependency information 87 have substitute counterparts, their SKUs are captured in the substitute product information 89 and the substitute part information 91 as well. Furthermore, in the event that no substitute products and/or parts are available or known for a wellsite procedure, the cells related to that particular procedure recite “N/A” to represent the lack of information. Similarly, any cells that are updated in real time initially recite “TBD” to signify that the substitute data will be added at a later date. Such may be necessary, for example, during a maintenance operation where it is unclear what products or parts need to be replaced at a wellsite prior to the operation.

Finally, the last column of the lookup table 80 includes substitute part price information 92. As discussed in relation to the price information 90, the substitute part price information 92 is determined by the purchase order module 41 based upon previous POs of substitute parts received by the manufacturing facility 13. Alternatively, the data may be manually input by an operator via the HMI 31 and the UI 37. As one example of the substitute part price information 92, the uppermost cell of the substitute part price information 92 recites “$23.15 (+12%)”, which indicates that the current cost of a substitute part with an SKU of 37544 has a price of $23.75, which has risen 12% from the previous cost. In the event that the substitute part price information 92 is lower than the price information 90, the purchase order module 41 directs the drilling operations module 43 to alert the operator, via the tie-in plans or tie-in menu (e.g., FIG. 5) with a text label or icon, that the substitute parts are more cost effective for the wellsite procedure.

Accordingly, overall, FIG. 4 depicts an example embodiment of a lookup table 80 as described herein. In particular, the lookup table 80 forms construction information that relates the products and parts to each wellsite procedure, as well as any substitute products and parts that can be used to complete the wellsite procedure and the cost thereof. In this way, the lookup table 80 is used by the materials module 49 and the drilling operations module 43. This information is, in turn, further utilized by the inventory management device 21 to determine if one or more additional POs are required to be submitted in order for the manufacturing facility 13 to possess a required quantity of parts and products for a particular wellsite procedure as described above.

However, the lookup table 80 only includes construction information related to the contemplated wellsite procedure. On the other hand, product and part inventory information is stored in an AI database 101 as further depicted in Table 1, below.

TABLE 1
AI Database

| | | Req. | Pr | Req. | Pa | Prod. | Part | For. | For. | S. | Prod | Part | O. |
|---|---|---|---|---|---|---|---|---|---|---|---|---|---|
| Op. | TTC | Product | LT | Parts | LT | Inv. | Inv. | Prod. | Part | Risk | Risk | Risk | Risk |
| Well 1 | 36 | 16849:6 | 8 | 15873:12 | 4, 4 | 16849:1; | 15873:3; | 5, −1 | 12, 0; | 0.8 | 1 | 0.9 | 0.9 |
| | | | | 15874:12 | | Jul. 29, 2023 | Sep. 2, 2023 | | 12, 0 | | | | |
| | | | | | | | 15874:3; | | | | | | |
| | | | | | | | Aug. 10, 2023 | | | | | | |
| Well 2 | 247 | 16849:6 | 8 | 15873:12 | 4, 4 | 16849:1; | 15873:3; | 25, 19 | 64, 40; | 0.2 | 0.1 | 0 | 0.1 |
| | | | | 15874:12 | | Jul. 29, 2023 | Sep. 2, 2023 | | 64, 40; | | | | |
| | | | | | | | 15874:3; | | | | | | |
| | | | | | | | Aug. 10, 2023 | | | | | | |
| Plug | 1,216 | 16142:1 | 36 | N/A | N/A | 16142:1; | N/A | 34, 33 | N/A | 0 | 0 | N/A | 0 |
| | | | | | | Jul. 18, 2023 | | | | | | | |
| | | | | | | [symbol] | | | | | | | |
| | | | | | | [symbol] | | | | | | | |

More specifically, Table 1 depicts an example of an Artificial Intelligence (AI) database 101 and outputs stored therein consistent with one or more embodiments of the described invention. Similar to the lookup table 80 depicted in FIG. 4, the Table 1 (i.e., the AI database 101) is formed as a series of rows and columns, where the rows correspond to potential wellsite procedures and the columns correspond to data related to a particular wellsite procedure. Thus, for exemplary purposes only, a scheduled operations column (i.e., the first column labeled “Op.”) of Table 1 includes a first well drilling operation (i.e., “Well 1”), a second well drilling operation (i.e., “Well 2”), and a well plugging operation (i.e., “Plug”). The well drilling operations are, for example, operations that involve using a drilling rig and drill bit to drill an experimental wellbore. The plugging operation, on the other hand, is an operation to install a cement (or equivalent material) well plug at a wellsite 17.

Each scheduled operation reflected in Table 1 is associated with a scheduled date, which is selected by an operator in the UI 37 as further discussed below. The date is reflected in the second column (i.e., the Time to Completion “TTC” column) of Table 1, where each cell of the TTC column specifies the amount of time, in hours, between a current time and the scheduled time of the wellsite procedure. Thus, as depicted in Table 1, the first new well procedure is scheduled to take place in 36 hours, while the second new well procedure is scheduled for 247 hours from a current time and the plugging operation is scheduled for 1,216 hours from a current time. As discussed in relation to FIG. 3, the values of the remaining time column (i.e., the Time to Completion “TTC” column) are determined by the drilling operations module 43 and retrieved and stored in the AI database 101 with the scheduling module 79. For example, the drilling operations module 43 determines the amount of days between the scheduled date of the wellsite procedure and the current date, and the scheduling module 79 requests this difference from the drilling operations module 43 and inputs the difference as an amount of hours into the remaining time column (i.e., the Time to Completion “TTC” column).

The products and parts necessary to complete the scheduled wellsite procedure are stored in the required products column (i.e., the third column labeled “Req. Product” of Table 1) and the required parts column (i.e., the fifth column labeled “Req. Parts” of Table 1), respectively. As discussed in relation to FIG. 4, the required products and parts are stored in a lookup table 80 by the materials module 49, and are copied into the AI database 101 by the time-series forecasting module 71 once a particular wellsite procedure is selected. This allows the AI model forming the demand quantity prediction module 51 and the demand risk prediction module 53 to forecast the demand and risk for a particular product or part, and further determine the overall risk of a scheduled wellsite procedure as a whole. The products and parts are stored as SKUs in the required products column (i.e., the third column labeled “Req. Product”) and the required parts column (i.e., the fifth column labeled “Req. Parts”), respectively, such that each cell includes the SKUs of products or parts associated with a specific wellsite procedure.

In order to better forecast the availability of products and parts for the wellsite procedures, Table 1 further includes a product lead time column (i.e., the fourth column labeled “PrLT”) and a part lead time column (i.e., the sixth column labeled “Pa LT”). These columns specify a forecast amount of time, in hours, determined by the workflow module 55, required for a manufacturing facility 13 to build the products and the supplier facility 15 to form the parts.

More specifically, the workflow module 55 is configured to derive the amount of lead time required to fulfill a Purchase Order (PO) for a part by determining the difference between a time when the PO was submitted and when a barcode identifying the part(s) requested in the PO is scanned at a manufacturing facility 13. As discussed above, the inventory data used to determine the moving average is received or determined by the workflow module 55 using scanners 29 or the supplier module 47, for example. The inventory data is stored in a current product quantity column (i.e., the seventh column labeled “Prod. Inv.”) and a current part quantity column (i.e., the eighth column labeled “Part Inv.”) in the form of timestamped data, as further discussed below. Thus, to compute the moving average, an averaging module 75 of the demand quantity prediction module 51 computes an average of the timestamped data for each product and part of the current product quantity column (i.e., the seventh column labeled “Prod. Inv.”) and the current part quantity column (i.e., the eighth column labeled “Part Inv.”), respectively. As each PO is submitted and fulfilled, the averaging module 75 updates this value to reflect the additional PO, such that the part lead time column (i.e., the sixth column labeled “Pa LT” of Table 1) reflects a real-time moving average of the total inventory received by the manufacturing facility 13. Similarly, the fourth column (i.e., the column labeled “Pr LT”), which relates to the lead time for a manufacturing facility 13 to form a product, is determined based upon a time between parts being scanned at a manufacturing facility 13 and an operator scanning an assembled product formed from the parts. Additionally, the moving average may only be determined for a period of previous time (e.g., the past 6 months), such that the part lead time column (i.e., the sixth column labeled “Pa LT.”) reflects the current ability of the supplier facility 15 to ship parts, without being influenced by previous computed averages. Similar restrictions may be placed upon the product lead time column (i.e., the column labeled “Pr LT”) without departing from the nature of this specification.

In a similar way, the AI model derives and stores the lead time to build a product in the product lead time column (i.e., the column labeled “Pr LT” in Table 1). Thus, the product lead time column is a reflection of the moving average amount of time between a manufacturing facility 13 scanning a barcode of the parts used to build the products (as step of receiving a shipment from a manufacturing facility 13) and the manufacturing facility 13 scanning a barcode of an assembled or otherwise fully formed product. The algorithm used to compute the lead times may be a boosted trees algorithm or a logical regression algorithm, for example, that is used by the averaging module 75 based upon data provided by the workflow module 55.

For example, the first and second well drilling operations reflected by the first and second rows of Table 1 use the same product (e.g., SKU 16849) to perform the new well drilling operation. Thus, the lead time to form the products is the same for the first and second rows of Table 1, and reflects that the product (e.g., SKU 16849) will take at least 8 hours to build after a manufacturing facility 13 has received the materials and/or parts to make the products from a supplier facility 15. Continuing with the example, and as described above, SKU 16849 may correspond to a drill bit used to drill the new well. In this case, the period of 8 hours reflects the time for a manufacturing facility 13 to manufacture a drill bit after an operator has received and scanned the barcode of raw materials (e.g., tungsten carbide) used to form the drill bit. Similarly, a lead time of 4 hours in the part lead time column (i.e., the column labeled “Pr LT”) implies that it will take at least 4 hours to for the supplier facility 15 to receive a PO, retrieve the raw materials (e.g., tungsten carbide) from a warehouse, and ship the raw materials to the manufacturing facility 13.

As discussed above, the number of requisite products and the number of requisite parts are input into the inventory management device 21 by an operator via the drilling operations module 43, where the operator manually inputs the amount of products with the HMI 31. For example, when an operator of the inventory management device 21 selects a particular wellsite procedure on the UI 37, the operator is presented with a menu (i.e., a tie-in menu) that allows the operator to select additional parts and/or products for the operation and quantities thereof. The number of required products is then stored in the lookup table 80 by the materials module 49, and copied into Table 1 in the required product quantity column (i.e., the third column labeled “Req. Product”). Similarly, the number of required parts needed to complete a wellsite procedure is stored on the lookup table 80 and copied into the required part column (i.e., the fifth column labeled “Req. Parts”).

Similar to the required product quantity column, an AI database 101 as described herein further includes a current product quantity column (i.e., the seventh column of Table 1 labeled “Prod. Inv.”) that details the current inventory reserves of products used in the wellsite procedure(s) that are located at the manufacturing facility 13. As discussed above, the information in the current product quantity column (i.e., the seventh column of Table 1 labeled “Prod. Inv.”) is timestamped inventory data, where the values of this column correspond to the number of products scanned by operators with scanners 29 at the manufacturing facility 13. Such is reflected in Table 1, for example, by the sequence “16849:1;7/29/2023”, which reflects that on Jul. 29, 2023, an operator at the manufacturing facility 13 scanned 1 assembled product with an SKU of 16849. The inventory data concerning the product reserves is determined and input into the AI database 101 by the workflow module 55, which interprets the scans captured with the scanner 29.

Similarly, a current part quantity column (i.e., the eighth column labeled “Part Inv.”) corresponds to the number of parts and/or raw materials possessed by the supplier facility 15. The part quantity data may be automatically fed into the AI database 101 as new supplier inventory data is submitted via the supplier module 47, for example. Additionally, the current part quantity column (i.e., the eighth column labeled “Part Inv.”) reflects quantities of the parts located at the manufacturing facility 13, which are scanned by the operators with scanners 29 as discussed above. This information is captured in the form of timestamped data that specifies the SKU of the product, the quantity received, and the date thereof. For example, the uppermost value of the current part quantity column (i.e., the eighth column labeled “Part Inv.”) recites “15873:3; Sep. 2, 2023” and “15874:3; Aug. 10, 2023”, which describes that three parts with an SKU of 15873 were received on Sep. 2, 2023, and three parts with an SKU of 15874 were received on Aug. 10, 2023. Thus, the current product quantity column and the current part quantity column (i.e., the seventh and eighth columns of Table 1) are forms of the manufacturer inventory data and supplier inventory data, respectively, as discussed above. The data of the current part quantity column is fed into the AI database 101 (i.e., Table 1) by way of the time-series forecasting module 71, which receives the inventory information supplier module 47 and the workflow module 55, depending upon whether the part is located at the manufacturing facility 13 or supplier facility 15. Overall, the current product quantity column and the current part quantity column, which form the seventh and eighth columns of Table 1, respectively, reflect the manufacturer inventory data and supplier inventory data discussed above.

Based upon a combination of all of the columns of Table 1 discussed above, the demand quantity prediction module 51 determines a forecast quantity of available products and a forecast quantity of available parts to be used in the wellsite procedure. The forecast quantity of available products is stored in the forecast available product quantity column (i.e., the ninth column labeled “For. Prod.”), while the forecast quantity of available parts is stored in the forecast available part quantity column (i.e., the tenth column labeled “For. Part.”). The values of the cells forming the forecast available product quantity column (i.e., the ninth column labeled “For. Prod.”) are determined based upon the relationship between the cells of the remaining time column, the product lead time column, the required product quantity column, and the current product quantity column, which are the second, fourth, third, and seventh columns of Table 1, respectively.

In particular, and by way of example, the value of “5,−1” in the uppermost cell of the forecast available product quantity column represents that a total of 5 products with an SKU of 16849 are likely to be available for use in the wellsite procedure, and that this quantity is one less than the required quantity. The value of 5 is derived from the fact that the manufacturing facility 13 is currently in possession of 1 product with SKU 16849 (i.e., the value in the current product quantity column), and the wellsite procedure is scheduled to be completed in 3 days (i.e., the value of the remaining time column). Based upon the remaining time being 36 hours, and that it will take 8 hours to form a product (i.e., the lead time in the product lead time column), the time-series forecasting module 71 determines that an additional 4 products may be formed during the remaining time. The time-series forecasting module 71 proceeds to add the current inventory (i.e., 1) to the number of additional products that may be formed (i.e., 4), and the summation thereof forms the forecast quantity of available products reflected in the cells of the forecast available product quantity column (i.e., the “Pr LT” column of Table 1). This process is further repeated for the second new well operation, in which case the demand quantity prediction module 51 concludes that 31 products with SKU 16849 (e.g., a drill bit) may be built in the remaining 247 hours.

However, and as depicted in Table 1, the cell of the current product quantity column (i.e., the “Prod. Inv.” column) related to the well plugging operation (i.e., the lowermost cell) includes errant data. In particular, the lowermost cell has a value of “16142:20;8/23/2023”, implying that the manufacturing facility 13 assembled 20 products with an SKU of 16142 (e.g., a well plug) on Aug. 23, 2023. As the product lead time column (i.e., the column labeled “Pr LT”) requires that it takes at least 36 hours to form a well plug, the predetermined limit of products used by the outlier module 73 of the demand quantity prediction module 51 will be relatively low. For example, the outlier module 73 may be equipped with a predetermined upper limit of a maximum of two products with an SKU of 16142, to account for cases where a manufacturing facility 13 receives an unused well plug with SKU 16142 from a wellsite 17 after completing a well plugging operation, and further forms a well plug with SKU 16142 at the same time. Thus, because a value of “20” products with an SKU of 16142 is improbable, and above the predetermined upper limit, the outlier module 73 deletes this data. Accordingly, when the demand quantity prediction module 51 determines the quantity forecast products for the well plug operation (e.g., the lowermost cell of the forecast available product quantity column), the demand quantity prediction module 51 will not include the errant data. Continuing with the example above, the forecast available product quantity column (i.e., the “For. Prod.” column of Table 1) depicts that a total of 34 products with an SKU of 16142 may be available for the wellsite procedure, which accounts for the current products possessed by the manufacturing facility 13, without the errant data of 20 additional products, and the lead time of 36 hours to build a new product.

The forecast number of available parts is determined by the demand quantity prediction module 51 using similar methods and algorithms. For example, and as depicted in Table 1, a particular wellsite procedure requires the use of 24 parts total, in the form of a series of two SKUs (e.g., SKUs 15873,15874) with a required quantity of 12 parts each. Based upon the lead time for the parts being 4 hours each, and there being a total of 36 hours before the wellsite procedure is completed, the demand quantity prediction module 51 concludes that a quantity of 9 of each part may be built in the remaining time. As the current part quantity column (i.e., the “Part Inv.” column of Table 1) indicates that a manufacturing facility 13 possesses 3 parts in its inventory, the demand quantity prediction module 51 concludes that 12 parts with SKU 15873 and 12 parts with SKU 15874 may be received by the manufacturing facility 13 prior to the wellsite procedure. Similarly, because the second wellsite procedure uses the same parts and products as the first wellsite procedure, the demand quantity prediction module 51 determines that 64 of each part may be built in the remaining 247 hours prior to the second new well procedure. As the well plug operation does not have any required parts, the demand quantity prediction module 51 writes a value of “N/A” to the cell of the current part quantity column (i.e., the eighth column of Table 1) corresponding to the well plug operation.

After computing the values of the forecast available product quantity column and the forecast available part quantity column, which make up the ninth and tenth columns of Table 1, the time-series forecasting module 71 of the demand quantity prediction module 51 proceeds to determine if there's a product and/or part deficit, and appends this data to the forecast products and forecast parts columns. In particular, the forecast product deficit data is determined by subtracting the forecast available product quantity column from the required product quantity column (i.e., the ninth and third columns of Table 1, respectively). This value represents the potential difference between the amount of products that a manufacturing facility 13 may build and the amount of products necessary to complete the wellsite procedure. Similarly, the forecast part deficit data reflects the difference between the forecast available part quantity column and the required part quantity column (i.e., the tenth and fifth column of Table 1, respectively). A positive value indicates that the manufacturing facility 13 is in possession of all required products and parts to complete the wellsite procedure, while a negative value indicates that the wellsite procedure cannot be completed as a consequence of not having enough products and/or parts. For example, and concerning the first new well operation, the forecast product column is updated to include a value of “5,−1”, where the value of “−1” indicates that a supplier facility 15 will not possess at least one of the products with SKU 16849. On the other hand, the forecast part column (i.e., the tenth column of Table 1) indicates that a manufacturing facility 13 will possess the exact number of parts with SKUs 15873 and 15874 (i.e., a part deficit of zero indicated by the value of “0” in the string “12,0”) that are required to complete the first new well operation.

The values of the forecast product quantity column and the forecast part quantity column for a particular wellsite procedure may further be influenced by the amount of parts and products required to complete a previous wellsite procedure. For example, based upon the lead times required to build the products used in the second new well operation (i.e., the “Pa LT” column of Table 1), the demand quantity prediction module 51 has forecast that a total of 31 products may be built, in addition to the 1 product that the manufacturing facility 13 currently possesses. However, because the second new well operation is scheduled after the first well operation, and the well operations use the same products, the inventory management module 77 of the demand quantity prediction module 51 subtracts the 6 products from the product deficit value reflected in the forecast product quantity column, such that this cell reads that 25 products are forecast to be available for the second wellsite procedure with a potential surplus of 19 products. In this way, the demand quantity prediction module 51 as a whole is configured to consider any relationships between operations to ensure that the operations may be completed while also accounting for products and parts used in the other wellsite procedures.

After determining the forecast product deficit and the forecast part deficit, the demand risk prediction module 53 determines values of a scheduling risk column (i.e., the eleventh column labeled “S. Risk”), a product risk column (i.e., the twelfth column labeled “Prod Risk”), a part risk column (i.e., the thirteenth column labeled “Part Risk”), and an overall risk column (i.e., the fourteenth column labeled “O. Risk”). The values of the scheduling risk column correspond to a scheduling risk associated with the particular wellsite procedure, and are determined as a function of the values of the remaining time column (i.e., the “TTC” column of Table 1). More specifically, the demand risk prediction module 53 assigns a weight, as a decimal value between 0 and 1, inclusive, based upon the amount of hours remaining before the wellsite procedure. In this regard, the demand risk prediction module 53 assigns and rewrites the value of this column to increase corresponding to the decrease in time, such that a high weight (e.g., 1) represents that a wellsite procedure is scheduled to occur in the immediate future, while a low weight (e.g., 0) represents that a wellsite procedure is scheduled to occur in the distant future. Thus, as depicted in Table 1, the first new well operation, which is scheduled for 36 hours from a current time, is associated with a weight of 1 (since it is close to the current time), while the well plug operation, which is scheduled for 1,216 hours from now, has a weight of 0. The rate of decay of the weights, as well as when the weights have values of 1 and 0, may be input by an operator while configuring an inventory management device 21 for a particular manufacturing facility 13.

In addition, the demand risk prediction module 53 considers the relationship between the forecast available product quantity column, the forecast available part quantity column, and the remaining time column (i.e., the ninth, tenth, and second columns of Table 1, respectively) when determining the product risk and the part risk. More specifically, the product risk column (i.e., the twelfth column of Table 1, labeled “Prod Risk”) is a weight with a value that corresponds to the risk of forming the required number of products prior to the scheduled date of the wellsite procedure.

For example, and as depicted in Table 1, the cell of the forecast product column for the first new well operation has a string of “5,−1”, where the value of “−1” indicates indicating that the manufacturing facility 13 will likely not have enough products to complete the first new well operation. On this basis, the demand risk prediction module 53 determines that there is a high risk that the first new well will not be drilled, and assigns a high weight of 1 to the uppermost cell of the product risk column. Similarly, because the manufacturing facility 13 is forecast to have the exact amount of parts for the first new well operation, the demand risk prediction module 53 assigns a relatively high risk weight of 0.9 to the uppermost cell of the part risk column (i.e., the thirteenth column of Table 1). On the other hand, because it is highly likely that the manufacturing facility 13 will be able to receive the products and parts necessary to complete the second new well procedure in the remaining 247 hours therebefore, the demand risk prediction module 53 assigns low risk weights of 0.1, and 0, respectively, to the scheduling risk column and the product risk column (i.e., the eleventh and twelfth columns of Table 1) for the second new well operation. Furthermore, because the manufacturing facility 13 already possesses the required number of products to complete the well plugging operation, the demand risk prediction module 53 determines that there is no product risk with the well plugging operation, and assigns a weight of 0 to this cell in the product risk column.

The overall risk column (i.e., the fourteenth column of Table 1) is an averaging column that is used by the demand risk prediction module 53 to determine the total level of risk associated with the wellsite procedure. Thus, to determine the values of the overall risk column, the demand risk prediction module 53 performs an averaging function on the values of the scheduling risk column, the product risk column, and the part risk column (i.e., the eleventh, twelfth, and thirteenth columns of Table 1) to derive the overall risk weight. The averaging function may be, for example, a simple average of the values, or a weighted average based upon the weights in the individual columns. For example, in a case where a wellsite procedure is scheduled in the immediate future and the manufacturing facility 13 is in possession of all the required products, the demand risk prediction module 53 may reduce or otherwise modify the value of the scheduling risk column since the remaining time is no longer a relevant factor to the completion of the wellsite procedure. Thus, the overall risk column (i.e., the final column of Table 1) reflects the final determination of whether a wellsite procedure is likely to be completed, where a high value indicates a high risk that the wellsite procedure will not be completed, and a low value indicates that the wellsite procedure will likely be completed at the scheduled date. Based upon the values of the overall risk column and as described herein, the demand quantity prediction module 51 may submit additional POs to a supplier facility 15 to ensure that the manufacturing facility 13 possesses enough products and parts to complete a wellsite procedure.

FIG. 5 depicts an example of a UI 37 consistent with one or more embodiments of the invention as described herein. The UI 37 is primarily formed of four graphical elements, which include a well menu 93, a tie-in menu 95, tie-in plans 97, and a calendar 99. As discussed above, the well menu 93 includes a drop-down menu of wellsite procedures 145 that an operator can schedule using the inventory management device 21. As depicted in FIG. 5, and as one example of potential wellsite procedures that can be scheduled, the well menu 93 includes procedures such as a new well drilling procedure, a well plug installation procedure, a pressure sensor installation procedure, a payload procedure, and a maintenance procedure. The well menu 93 also includes dates in a date menu 147 that the various procedures may be scheduled for, such that an operator of the inventory management device 21 selects the wellsite procedure and a corresponding date in order to schedule a wellsite procedure. The various wellsite procedures and the potential dates for the procedures reflected in the date menu 147 are stored on the memory 27 and are generated and maintained by the drilling operations module 43 and stored and retrieved on the AI database 101 using the scheduling module 79. Dates and procedures available to the operator may be input manually via the HMI 31, or determined by the inventory management device 21 based upon other current and previous wellsite procedures. For example, the drilling operations module 43 may present a list of dates that are a predetermined amount of time (e.g., 3 days) from any other scheduled wellsite procedure.

Once a particular wellsite procedure is selected with the well menu 93, the tie-in menu 95 provides an interface for the operator to view and select product and parts to be used in the selected procedure. Thus, the tie-in menu 95 includes a list of the required and substitute product(s) and part(s) used in the wellsite procedure, as well as a checkbox 139 for selecting whether substitute products and parts may be used in the procedure. For example, in a case where the operator selects a new well drilling operation, the tie-in menu 95 depicts that the drilling operation requires a product with an SKU of 16849, or substitute products with SKUs of 16750 and 18651, since the checkbox 139 is checked. The tie-in menu 95 further includes a list of the required parts for the drilling operation, which includes SKUs of 15873 and 15874, or substitute parts with SKUs of 37544 and 37545.

The tie-in menu 95 further includes an additional components menu 141 that allows the operator to select additional products and parts to be used in the wellsite procedure selected in the well menu 93. As depicted in FIG. 5, the additional components menu 141 includes a component drop-down menu 149 specifying additional products and parts that may be used in the wellsite procedure, as well as a quantity input box 151. The component drop-down menu 149 includes a list of products and/or parts returned from the materials module 49, which includes some or all of the products and parts possessed by the manufacturing facility 13. The list may further only include products and parts that have previously been used (but are not indicated as being required) in a similar wellsite procedure, or the list may be manually formed by an operator or owner of the inventory management device 21 when the inventory management device 21 is configured for a particular manufacturing facility 13. Once an additional component (i.e., a product or part) is selected with the component drop-down menu 149, the operator manually enters the quantity of the required part in the quantity input box 151. Subsequently, the tie-in menu 95 is updated to include the additional components as required products or parts for the procedure. In this way, the operator that selects and schedules a wellsite procedure is able to select additional components and quantities thereof, which allows a generic wellsite procedure to be adapted to the specific logistics of a particular wellsite procedure. The additional components are stored in lookup table 80 by the materials module 49, and further copied into the required products column, the product lead time column, and the required part quantity column of the AI database 101 (i.e., the third, second, and fifth columns of Table 1, respectively) the by the time-series forecasting module 71.

As one example of where the tie-in menu 95 may be beneficial, a specific new well drilling operation may be scheduled for a wellsite with a large amount of bedrock, such that the drilling operation will be more difficult than previously completed well drilling operations. In this case, the operator may determine that additional drill bits (e.g., SKU 17643) are required for the specific new well drilling operation, as all of the drill bits are expected to fail while drilling through the bedrock. The operator then proceeds to select the SKU 17643 (which corresponds to the drill bit used in the operation), as well as the estimated quantity of additional drill bits needed. This, in turn, ensures that the inventory management device 21 as a whole schedules the specific new well drilling operation for a time when the additional drill bits may be acquired, and further ensures that the manufacturing facility 13 is aware that it must acquire or form additional drill bits before the operation. In the event that POs are required in order to acquire additional parts to be used in the wellsite procedure, the inventory management module 77 submits the additional POs to the supplier facility 15 via the purchase order module 41 as described above.

While the well menu 93 and the tie-in menu 95 serve to allow an operator to schedule and modify potential wellsite procedures, the tie-in plans 97 and the calendar 99 serve to present information back to the operator concerning the status of the scheduled wellsite procedures. More specifically, the calendar 99 presents a graphical depiction of a current month, as well as a checkmark on any days that a wellsite procedure is selected. This allows the operator to quickly verify which days that wellsite procedures are scheduled for, and further offers the operator the ability to visually double-check that a wellsite procedure has been scheduled for the correct date. In addition, an operator may click on the checkmark, or the date associated therewith, in which case the tie-in plans 97 presents information related to the wellsite procedure for that date. For example, and as depicted in FIG. 5, the calendar 99 reflects that a wellsite procedure is scheduled for the 7 Sep. 2023. Once the operator selects the date of September 7th, the UI 37 graphically superimposes a circle onto the selected date, which is depicted as the selected date 153, which further allows the operator to visually verify that the correct date is selected.

Continuing with the example where the operator selects a date of September 7th, the tie-in plans 97 presents an overview of the scheduled wellsite procedure. More specifically, and as depicted in FIG. 5, the tie-in plans 97 specifies that the wellsite procedure is a new well drilling procedure that involves drilling an exploration well, which is commonly used to determine if a wellsite 17 is suitable for future payload operations. The tie-in plans 97 further presents the date of the new well drilling procedure (e.g., September 7th), as well as any interconnectivity between the scheduled wellsite procedure and previously completed procedures. The interconnectivity field presents information to the operator describing if the new well is supposed to be laterally connected to an existing well, for example. However, because in the example described above an exploration well is being drilled, there is no interconnectivity information for this particular procedure. The tie-in plans 97 further presents the associated risk with a particular wellsite procedure, which is equivalent to the overall risk determined in the overall risk column described in relation to Table 1 (e.g., the column labeled “O. Risk”). The above data presented in the tie-in plans 97 may be retrieved, for example, from the AI database 101 using the drilling operations module 43, or fed directly to the UI 37 from the time-series forecasting module 71 of the demand quantity prediction module 51.

In addition to presenting the logistical parameters of the wellsite procedure, the tie-in plans 97 further includes a live feed 155 that presents real-time data related to the scheduled wellsite procedure. Continuing with the example of drilling an exploration well, the drilling rig used to drill the exploration well is equipped with a downhole pressure sensor that measures the internal pressure of the exploration well as it is being drilled (e.g., FIG. 6). Thus, the live feed 155 presents the downhole pressure of the exploration well in real-time, and is depicted as being a value of 4,000 psi in FIG. 5. The data presented in the live feed 155 is transmitted to the inventory management device 21 by way of the transceiver 23, for example, which forms a wireless data connection with the downhole pressure sensor (e.g., FIG. 6) used in the wellsite procedure. Once the wellsite procedure is completed, the operator selects that the wellsite procedure is completed by selecting a procedure completion checkbox 157, which informs the inventory management device 21 that the particular wellsite procedure is complete. In the event that the downhole pressure sensor stops transmitting live data prior to an operator indicating that the wellsite procedure is complete via the procedure completion checkbox 157, the inventory management device 21 concludes that the wellsite procedure has failed, and reschedules the wellsite procedure for a later date automatically by way of the drilling operations module 43 as described above. In this way, the inventory management device 21 is further configured to respond, in real time, to the wellsite procedure and any challenges that arise as a consequence thereof.

Turning to FIG. 6, FIG. 6 depicts a wellsite 17 consistent with one or more embodiments of the invention described herein, and more specifically depicts a wellsite 17 at which a new wellbore 159 is being drilled. In general, well sites are configured in a myriad of ways. Therefore, the wellsite 17 is not intended to limit the particular configuration of the drilling equipment. For example, the wellsite 17 is depicted as being on land, however the wellsite 17 may be offshore and drilling may be carried out with or without the use of a marine riser. Moreover, various components and details of the wellsite 17 that would be well known to a person of ordinary skill in the art have been omitted for the sake of brevity.

A drilling operation at the wellsite 17 is initiated by drilling a wellbore 159, or borehole, into a subterranean formation 161, which may be bedrock or soil, for example. More specifically, the process of drilling a wellbore 159 involves using a drilling rig 167 to rotate a drill bit 163. The drill bit 163 is disposed at the end of a bottom hole assembly 165, which is connected to a drilling rig 167 disposed at the surface of the wellsite 17. The drilling rig 167 is connected to the drill bit 163 by way of a bottom hole assembly 165 and a drill string 169, which are components that serve to orient the drill bit 163 within the wellbore 159 and assist the drill bit 163 in breaking down the subterranean formation 161. That is, and as is commonly known in the art, a drill string 169 is a series of tubes that transmit drilling mud (not shown) and torque to the bottom hole assembly 165 and drill bit 163, while a bottom hole assembly 165 includes components such as reamers and stabilizers (not shown) that position the drill bit 163 in the wellbore 159. Accordingly, the drilling rig 167 is configured to used internal components such as a crown block or power generation equipment (not shown) to apply a downward force on the drill string 169, which is transmitted to the drill bit 163 by way of the drill string 169 and the bottom hole assembly 165. In turn, this causes blades (not shown) of the drill bit 163 to scrape away the subterranean formation 161 to extend the wellbore 159. Thus, overall, the wellbore 159 is created by scraping away the subterranean formation 161 with the drill bit 163 using power supplied by the drilling rig 167.

As is further depicted in FIG. 6, the bottom hole assembly 165 includes a downhole pressure sensor 171 that serves to capture the internal pressure of the wellbore 159 as the drill bit 163 breaks down the subterranean formation 161. The downhole pressure sensor 171 may be, for example, a diaphragm type of pressure sensor that measures the displacement of a diaphragm as a function of the fluid pressure provided thereto. The downhole pressure sensor 171 is further equipped with a wired or wireless transmitter such as a Wi-Fi card (not shown), that forms a data connection with the inventory management device 21 using the transceiver 23, for example. During the process of drilling the wellbore 159, the downhole pressure captured by the downhole pressure sensor 171 is output to the tie-in plans 97 (e.g., FIG. 5) by the drilling operations module 43, which allows an operator located away from the wellsite 17 to view the progress of the drilling operation. In this example, the downhole pressure sensor 171 is a product built by a manufacturing facility 13, while the drill string 169 is one example of a part formed by a supplier facility 15 as described above.

The data captured by the downhole pressure sensor 171 further allows the inventory management device 21 to determine if additional wellsite procedures are necessary. For example, in the event that an inventory management device 21 has not received confirmation that the wellsite procedure has been completed, and has stopped receiving data from the downhole pressure sensor 171, the inventory management device 21 determines that the operation remains incomplete. In this case, the drilling operations module 43 of the inventory management device 21 schedules an additional wellsite procedure to continue the process of drilling the new well, and confirms that an additional downhole pressure sensor is possessed by the manufacturing facility 13 such that the additional wellsite procedure may be completed. Additionally, the inventory management device 21 is configured with predetermined minimum and maximum live data limits for each type of sensor that transmits live data thereto. In the event that the live data exceeds the predetermined limits, the inventory management device 21 also concludes that the downhole pressure sensor 171 is faulty and needs to be replaced.

In cases where the manufacturing facility 13 does not possess any reserve inventory of the downhole pressure sensor 171, the inventory management device 21 further submits a PO to the supplier facility 15, via the supplier module 47, that is fulfilled by the supplier facility 15 to enable the manufacturing facility 13 to complete the additional wellsite procedure. As discussed above, the determination of whether the inventory management device 21 needs to submit an additional PO relies upon the forecast available part quantity column of the AI database 101 (e.g., the tenth column of Table 1), and is determined by the inventory management module 77 of the demand quantity prediction module 51. Thus, the downhole pressure data captured by the downhole pressure sensor 171 is used by the inventory management device 21 to automatically reschedule failed wellsite procedures based upon real-time data thereof, and automatically order replacement parts for the wellsite procedure.

Furthermore, in a case where the failed product or part is not easily replaceable, the inventory management device 21 may schedule wellsite procedures of a different type in order to account for the failed product or part. For example, in a case where a drilling rig drilling rig 167 breaks while performing a new well drilling procedure, and the inventory management device 21 receives data that the drilling rig 167 can no longer function, it is insufficient for the inventory management device 21 to reschedule the new drilling procedure, as the drilling rig 167 requires maintenance to proceed with the drilling procedure. In this case, the inventory management device 21 concludes that a maintenance operation must be completed prior to the additional well drilling operations, and uses the drilling operations module 43 to schedule both operations. The determination that the drilling rig 167 itself has failed may be determined by static (i.e., not changing) values of the live feed 155, which indicates that the wellsite procedure has paused. Based upon the results of the diagnostic operation, and the inventory levels possessed by the manufacturing facility 13 overall, the demand quantity prediction module 51 may direct the purchase order module 41 to submit additional POs for additional parts. Thus, overall, the values provided by the downhole pressure sensor 171 allow the inventory management device 21 to determine and facilitate the operation of the wellsite 17 as a whole, such that a contemplated wellsite procedure is automatically revised as logistical challenges arise during wellsite 17 operations.

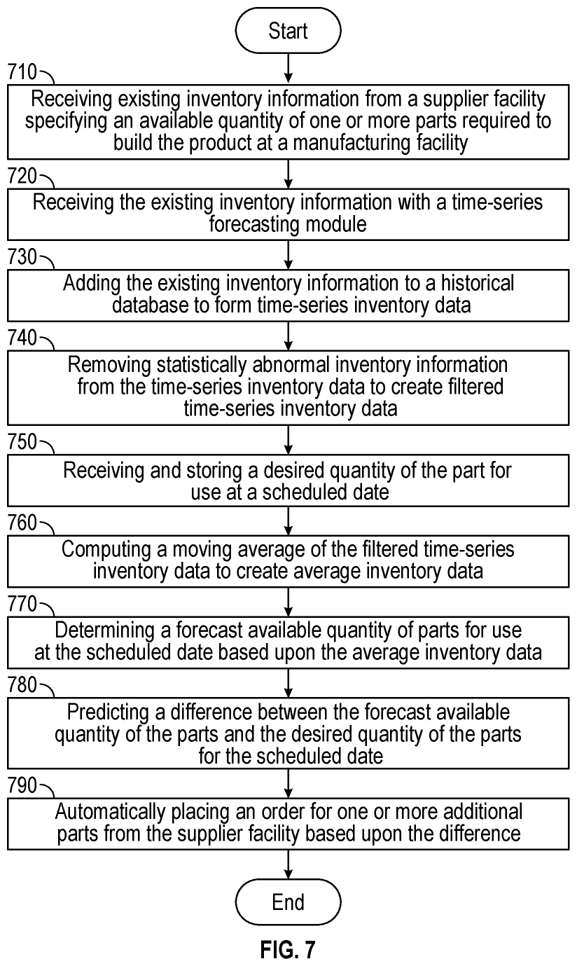

FIG. 7 depicts a method for automatically submitting a purchase order for additional parts according to one or more embodiments of the invention. Steps of FIG. 7 may be performed, for example, using the aforementioned inventory management device 21, but are not limited thereto. The constituent steps of the method depicted in FIG. 7 may be performed in any logical order, and are not limited to the sequence presented. Furthermore, the steps of FIG. 7 may encompass multiple additional actions not depicted that are routine in the art. Moreover, multiple steps of FIG. 7 may be performed as part of a single action, or a single step may comprise multiple actions.

The method of FIG. 7 initiates at step 710, which requires receiving existing inventory information from a supplier facility specifying an available quantity of one or more materials required to build a product at a manufacturing facility. As described herein, the existing inventory information takes the form of supplier inventory data including information specifying one or more parts, located at a supplier facility, that are used in wellsite procedures by a manufacturer to form products used to initiate or maintain a wellbore. The supplier inventory data reflects a number of parts produced and shipped by the supplier facility 15, and the phrase “parts” as used herein describes raw materials or subassembly components that are used by a manufacturing facility 13 to form various products to be used in a wellsite procedure. Similarly, the phrase “products” refers to devices, assemblies, and components such as drill bits, well plugs, sensors, etc. used in a wellsite procedure. Following the same logic, examples of wellsite procedures as described herein include drilling a new wellbore, performing a well remediation operation, installing sensors to an existing wellbore, performing maintenance, and other related actions performed to extend the life and usefulness of a wellsite 17.

As a whole, the existing inventory information reflects an available quantity of one or more raw materials and/or goods located at a supplier facility 15 and products located at a manufacturer facility 13, where the raw materials and goods are used to build, assemble, or otherwise form parts and/or products used in the wellsite procedure. The existing inventory information is transmitted to an inventory management device 21 by way of a data connection 35, and is stored on the memory 27 with the supplier module 47. Once the existing inventory information is transmitted to the manufacturing facility 13 and received by the supplier module 47, the method proceeds to step 720.

In step 720, a time-series forecasting module 71 of the demand quantity prediction module 51 receives the existing inventory information. As discussed in relation to FIG. 2, the demand quantity prediction module 51 is a module of the inventory management device 21 formed as a series of instructions, algorithms, processes, etc. that serve to process the inventory data, and the demand quantity prediction module 51 is stored on the memory 27. The supplier module 47 is similarly stored on the memory 27. Thus, step 720 comprises the time-series forecasting module 71 requesting the inventory data from the supplier module 47, and receiving the existing inventory information therefrom.

In step 730, the time-series forecasting module 71 adds the existing inventory information to an AI database 101. The AI database 101 includes previous inventory information such that the AI database 101 includes time-series inventory data reflecting a historically available quantity of the parts and products. More specifically, each data point of the existing inventory information is timestamped such that the AI database 101 includes a series of data points reflecting inventories of a supplier facility 15 and a manufacturer facility 13, and the times that the inventories were taken. Such data is reflected, for example, in the current product quantity column and the current part quantity column columns, which correspond to the seventh and eighth columns of Table 1, respectively. The time-series forecasting module 71 proceeds to coalesce the multiple instances of existing inventory data and their associated timestamps into time-series data of a single cell of the AI database 101. The multiple instances of existing inventory data may be generated by the workflow module 55 based upon an amount of inventory located at the supplier facility 15 or the manufacturer facility 13, and copied from the workflow module 55 into the AI database 101 by the time-series forecasting module 71.

Alternatively, the existing inventory information may be manually input by way of an HMI 31 located at the manufacturer facility 13, for example, or input directly into the AI database 101 with the workflow module 55. Once the existing inventory information has been added to the AI database 101 such that the AI database 101 includes time-series inventory data comprising a historically available quantity of the materials, parts, and products the method proceeds to step 740.

In step 740, an outlier module 73 of the demand quantity prediction module 51 removes statistically abnormal data from the time-series inventory data to create filtered time-series data. During this step, the outlier module 73 accesses the AI database 101, and deletes values below a first predetermined value and above a second predetermined value, such that the time-series inventory data is bounded between two predetermined inventory limits. This ensures that the demand quantity prediction module 51 does not errantly forecast available quantities of products based on the statistically abnormal data. The abnormal data may arise from situations, for example, where a supplier is unable to fulfill POs, or situations where a wellsite procedure is canceled such that products that were to be used in the canceled wellsite procedure remain unused, inflating the inventory data for the manufacturing facility 13. Such errant data, and its deletion thereof, is visually depicted by the crossed-out sequence “16142:20;8/23/2023” depicted in the lowermost cell of the current product quantity column (i.e., the seventh column of Table 1), which represents an instance where the outlier module 73 has determined that the inventory data is likely errant and has discarded data. The predetermined filtering values may be set by a managing entity of the manufacturing facility 13, for example. Once the filtered time-series data is created by the outlier module 73, the method proceeds to step 750.

In step 750, a scheduling module 79 of the demand quantity prediction module 51 receives and stores a required quantity of a part for use a scheduled date of a wellsite procedure. The desire quantity of the part is determined as a joint operation between a drilling operations module 43 and a materials module 49 of an inventory management device 21, where an operator selects a wellsite procedure via the drilling operations module 43 and the materials module 49 determines the bill of materials including a number of required parts to be used in the selected wellsite procedure using a lookup function to search a lookup table 80. Once the bill of materials is determined by the materials module 49, the scheduled date and the bill of materials are input into the AI database 101 by the scheduling module 79 of the demand quantity prediction module 51. In particular, the scheduling module 79 accesses the scheduling data of the drilling operations module 43 via the memory 27, and stores the bill of materials and scheduled date of the wellsite procedure in the AI database 101 such that the AI database 101 includes the required products as well as the contemplated use time thereof. Such data is visually depicted, for example, by the scheduled operations column, the remaining time column, and the required products column of the AI database 101, which correspond to the first, second, and third columns of Table 1, above. Once the scheduling module 79 receives the quantity of required parts, and inputs the quantity of required parts and associated dates into the AI database 101, the method proceeds to step 760.

In step 760, an averaging module 75 of the demand quantity prediction module 51 computes a moving average of the filtered time-series data to determine the values of the product lead time column and the part lead time column (i.e., the fourth and sixth columns of Table 1, respectively). This, in turn, allows the demand quantity prediction module 51 to determine the production rate of parts and products by the manufacturing facility 13 and the supplier facility 15. To compute the moving average, the averaging module 75 sums all of the filtered time-series data reflected in the current product quantity column and the current part quantity column (i.e., the seventh and eighth columns of Table 1) for a predetermined time period, and divides the summation by the amount of time required to fulfill the POs or assemble the products that are averaged. This average is then periodically updated to reflect additional parts and/or products received or built. In this way, the updated average forms a moving average of the historical time period required to receive a part or build a product, for example. Once moving average has been determined by the AI database 101, the method proceeds to step 760.

Based upon the average inventory data reflecting the moving averages of the filtered time-series data, the time-series forecasting module 71 of the demand quantity prediction module 51 determines a forecast available quantity of parts for use at the scheduled date in step 760 using the time-series forecasting module 71. Specifically, this step includes forming relationships with the time-series forecasting module 71 between the periods of time reflected by the moving averages in the product lead time column and the part lead time column (i.e., the fourth and sixth columns of Table 1, respectively), the inventory reserves of parts and products available to the manufacturing facility 13 reflected in the current product quantity column and the current part quantity column (i.e., the seventh and eighth columns of Table 1, respectively), and the scheduled wellsite procedure reflected by the scheduled operations column and remaining time column of the AI database 101, which correspond to the first and second columns of Table 1 above. The relationships may include, for example, a rate at which the products and parts are built reflected in the product lead time column and part lead time column (i.e., the fourth and sixth columns of Table 1, respectively), or a relationship between the lead times and the remaining time prior to the scheduled wellsite procedure. The process of forming the relationships is performed with an AI model of the time-series forecasting module 71 of the demand quantity prediction module 51, which uses algorithms such as boosted trees and random trees that assign and update weights representing the relationships described above. In this way, the AI model employed by the demand quantity prediction module 51 is capable of forming complex, multi-input relationships, which are used to forecast the available quantity of products for the scheduled wellsite procedure. Once the demand quantity prediction module 51 forecasts the quantity of parts available on the scheduled date to complete the wellsite procedure, the method proceeds to step 770.

In step 770, the inventory management module 77 of the demand quantity prediction module 51 predicts a difference between the forecast available quantity of parts and the required quantity of parts s for the scheduled date, which is reflected in the forecast part quantity column of the AI database 101. As discussed above, the prediction may be simple, where the inventory management module 77 of the demand quantity prediction module 51 subtracts the required part quantity column (e.g., the third column of Table 1) from the forecast available part quantity column (e.g., the tenth column of Table 1). Alternatively, the prediction may encompass multiple additional parameters, such as minimum inventory reserves that a manufacturing facility 13 is required to have on hand or the ability of a manufacturing facility 13 to acquire substitute parts prior to the scheduled date. In cases where the forecast quantity is greater than the required quantity (i.e., the forecast product deficit or forecast part deficit is positive), the demand quantity prediction module 51 indicates to the operator via the tie-in menu 95 that the necessary products and parts to complete the wellsite procedure are available for use. Alternatively, if the required quantity exceeds the forecast quantity such that the wellsite procedure cannot be completed, the method proceeds to step 780.

In step 780, the demand quantity prediction module 51 automatically submits a purchase order to a supplier facility 15 requesting one or more additional parts based upon the difference computed in step 770. More specifically, the inventory management module 77 of the demand quantity prediction module 51 transmits instructions to the purchase order module 41 with the identity and quantity of needed parts, where the quantity of needed parts corresponds to the difference between the forecast and required quantities of parts. Such a difference is reflected, for example, as a positive or negative value appended in the forecast product quantity column and the forecast part quantity column (i.e., the ninth and tenth columns of Table 1), where a negative number indicates that additional products and/or parts are required to complete the wellsite procedure. The purchase order module 41 proceeds to transmit the PO to the supplier facility 15 via the data connection 35, which ensures that any additional parts are received prior to the scheduled date of the wellsite procedure. To this end, by automatically requesting the additional parts immediately following a selection of a wellsite procedure, the demand quantity prediction module 51 ensures that the supplier facility 15 is provided with the maximum possible amount of time to supply the necessary parts. Thus, as a whole, the method of FIG. 7 ensures that a wellsite procedure is completed in a timely manner by ensuring that a manufacturing facility 13 is in possession of all the required parts and products needed to complete the wellsite procedure prior to the scheduled date.

Accordingly, the aforementioned embodiments of the invention as disclosed relate to devices and methods useful for managing inventory of parts and products related to a scheduled or contemplated wellsite procedure. In addition, embodiments of the invention are capable of performing real time actions related to the inventory management, such as increasing or decreasing the production rate of the manufacturing facility based upon contemplated wellsite procedures. Furthermore, embodiments of the invention receive the benefits of ensuring that all necessary parts and products required to complete the wellsite procedure are possessed by the manufacturer facility prior to the scheduled date of the wellsite procedure.

Although only a few embodiments of the invention have been described in detail above, those skilled in the art will readily appreciate that many modifications are possible in the example embodiments without materially departing from this invention. For example, the AI model employed by the inventory management device may be supervised or unsupervised, and may use regression algorithms rather than the boosted trees algorithm described herein. Furthermore, the procedure completed by the manufacturing facility may reflect any number of wellsite procedures not discussed herein, or may encompass non-wellsite related procedures for commercially available products. Accordingly, all such modifications are intended to be included within the scope of this disclosure as defined in the following claims.

What is claimed is:

1. An inventory management device, the device comprising:
a transceiver configured to receive existing inventory information from a supplier facility, the existing inventory information specifying an available quantity of one or more parts required to build a product at a manufacturing facility;
a processor configured to execute a series of modules forming a demand quantity prediction unit, the series of modules comprising:
a time-series forecasting module configured to receive the existing inventory information and add the existing inventory information to an AI database comprising previous inventory information such that the AI database includes time-series inventory data comprising a historically available quantity of the parts and further includes a historically available quantity of products built by the manufacturing facility;
an outlier module configured to remove statistically abnormal inventory information from the time-series inventory data to create filtered time-series inventory data;
a scheduling module configured to receive and store a required quantity of the part for use at a scheduled date;
an averaging module configured to compute a moving average of the filtered time-series inventory data to create average inventory data,
wherein the time-series forecasting module is further configured to determine a forecast available quantity of parts for use at the scheduled date based upon the average inventory data, and
an inventory management module configured to predict a difference between the forecast available quantity of the parts and the required quantity of the parts for the scheduled date, and automatically place an order for one or more additional parts from the supplier facility based upon the difference,
wherein the products are used at a wellsite to complete one or more wellsite procedures.

2. The inventory management device of claim 1, further comprising: a memory comprising a non-transient storage medium configured to store the series of modules.

3. The inventory management device of claim 1, wherein the time-series forecasting module is configured to periodically update the time-series inventory data with new inventory information received from the supplier facility.

4. The inventory management device of claim 1, wherein the inventory management device is configured to automatically place the order for the parts from the supplier facility by transmitting a purchase order to the supplier facility via a data connection.

5. The inventory management device of claim 1, wherein the inventory management device is further configured to automatically place the order for additional parts when the available quantity of parts is forecast to fall below a predetermined minimum inventory of parts.

6. The inventory management device of claim 1, further comprising: a scanner configured to capture one or more barcodes representative of a Stock Keeping Unit (SKU) of the one or more parts received from the supplier facility.

7. The inventory management device of claim 6, wherein the inventory management device is further configured to assign a weight associated with a contemplated risk of not having enough parts to complete a wellsite procedure.

8. The inventory management device of claim 7, wherein the inventory management device is further configured to compare a number of barcodes captured by the scanner to a purchase order corresponding to the one or more parts, and determine if a quantity of received parts is less than a quantity of requested parts.

9. The inventory management device of claim 7, wherein the inventory management device is further configured to notify the supplier facility and request additional parts when the quantity of received parts is less than the quantity of requested parts.

10. The inventory management device of claim 1, wherein the wellsite procedures comprise one or more operations that: initiate one or more new wellbores, maintain an existing wellbore or series of wellbores, remediate damaged or aging wells, determine a geometry, a composition, or an orientation of a wellbore, and acquire tangible goods from the wellbore.

11. The inventory management device of claim 1, wherein the statistically abnormal inventory information comprises inventory information specifying that the available quantity of the one or more parts is less than a first predetermined quantity of the one or more parts or greater than a second predetermined quantity of the one or more parts.

12. A method for managing an inventory of a product, the method comprising:
receiving existing inventory information from a supplier facility with a transceiver, the existing inventory information specifying an available quantity of one or more parts required to build the product at a manufacturing facility;
executing, with a processor, a series of modules that form a demand quantity prediction unit, the execution comprising:
receiving, with a time-series forecasting module of the demand quantity prediction unit, the existing inventory information;
adding the existing inventory information to an AI database with the time-series forecasting module, the AI database comprising previous inventory information such that the AI database includes time-series inventory data comprising a historically available quantity of the parts and a historically available quantity of products built by the manufacturing facility;
removing, with an outlier module of the demand quantity prediction unit, statistically abnormal inventory information from the time-series inventory data to create filtered time-series inventory data;
receiving and storing, with a scheduling module of the demand quantity prediction unit, a required quantity of the part for use at a scheduled date;
computing, with an averaging module of the demand quantity prediction unit, a moving average of the filtered time-series inventory data to create average inventory data;
determining, with the time-series forecasting module, a forecast available quantity of parts for use at the scheduled date based upon the average inventory data;
predicting, with an inventory management module of the demand quantity prediction unit, a difference between the forecast available quantity of the parts and the required quantity of the parts for the scheduled date, and
automatically placing an order for one or more additional parts from the supplier facility, based upon the difference, with the inventory management module,
wherein the products are used at a wellsite to complete one or more wellsite procedures.

13. The method of claim 12, further comprising: storing the series of modules with a memory comprising a non-transient storage medium.

14. The method of claim 12, further comprising: periodically updating the time-series inventory data with new inventory information received from the supplier facility with the time-series forecasting module.

15. The method of claim 12, further comprising: automatically placing the order for the parts from the supplier facility by transmitting a purchase order to the supplier facility via a data connection.

16. The method of claim 12, further comprising: automatically placing the order for additional parts when the available quantity of parts is predicted to fall below a predetermined minimum inventory of parts.

17. The method of claim 12, further comprising: capturing one or more barcodes representative of a Stock Keeping Unit (SKU) of the one or more parts received from the supplier facility with a scanner.

18. The method of claim 17, further comprising: increasing and decreasing the existing inventory information with the inventory management module in an amount corresponding to a number of barcodes captured by the scanner.

19. The method of claim 17, further comprising: comparing a number of barcodes captured by the scanner to a purchase order corresponding to the one or more parts with the inventory management module, and determining if a quantity of received parts is less than a quantity of requested parts with the inventory management module.

20. The method of claim 17, further comprising: notifying the supplier facility with the inventory management module and requesting additional parts when the quantity of received parts is less than the quantity of requested parts.
